(19) United States
(12) Patent Application Publication
(10) Pub. No.: US 2024/0104534 A1
(43) Pub. Date: Mar. 28, 2024

(54) TRANSACTION PROCESSING APPARATUS, COMMODITY SALES SYSTEM, AND INFORMATION PROCESSING PROGRAM

(71) Applicant: Toshiba Tec Kabushiki Kaisha, Tokyo (JP)

(72) Inventors: Hikaru KOMIYAMA, Yokohama Kanagawa (JP); Kanako NAKAHARA, Shinagawa Tokyo (JP)

(21) Appl. No.: 18/366,649

(22) Filed: Aug. 7, 2023

(30) Foreign Application Priority Data
Sep. 27, 2022 (JP) 2022-153884

(51) Int. Cl. G06Q 20/12; G06Q 20/32

(52) U.S. Cl. CPC G06Q 20/127; G06Q 20/322

(57) ABSTRACT

According to one embodiment, a transaction processing apparatus includes a communication interface to connect to a communication network, a storage unit for storing a store database with setting information indicating a service available period for a store, and a processor. The processor is configured to receive a registration start instruction via the communication interface from a terminal apparatus operated by a user in the store, determine whether the registration start instruction has been received in the service available period for the store by reference to the stored setting information for the store, and then permit the user of the terminal apparatus to register a commodity designated using the terminal apparatus in a sales transaction only if the registration start instruction was received in the service available period for the store.

### CROSS-REFERENCE TO RELATED APPLICATION

This application is based upon and claims the benefit of priority from Japanese Patent Application No. 2022-153884, filed Sep. 27, 2022, the entire contents of which are incorporated herein by reference.

### FIELD

Embodiments described herein relate generally to a transaction processing apparatus, a commodity sales system, and an information processing program.

### BACKGROUND

A system that performs transaction processing uses an information communication terminal owned by a customer, such as a smartphone, or an information communication terminal lent from a store as a user interface is called a “smartphone POS system” or the like. A transaction processing system that performs transaction processing using an information communication terminal attached to a shopping cart provided in the store as a user interface is called a “cart POS system”.

In such transaction processing systems, it is desired for use within a certain time period to be restricted even when that time period is within normal business hours of the store.

### BRIEF DESCRIPTION OF THE DRAWINGS

FIG. 1 is a block diagram of a transaction processing system according to an embodiment.

FIG. 2 is a block diagram of a transaction processing apparatus.

FIG. 3 is a diagram schematically illustrating a configuration of one data record included in a store database.

FIG. 4 is a diagram schematically illustrating a configuration of transaction data.

FIG. 5 is a block diagram of an attendant terminal.

FIG. 6 is a block diagram of a user terminal.

FIG. 7 is a block diagram illustrating a cart terminal.

FIG. 8 is a flowchart of user terminal processing.

FIG. 9 is a flowchart of user terminal processing.

FIG. 10 is a flowchart of smartphone POS processing.

FIG. 11 is a flowchart of smartphone POS processing.

FIG. 12 is a flowchart of smartphone POS processing.

FIG. 13 is a diagram illustrating a use unavailability screen.

FIG. 14 is a diagram illustrating a registration screen.

FIG. 15 is a diagram illustrating a commodity scan screen.

FIG. 16 is a diagram illustrating a registration confirmation screen.

FIG. 17 is a diagram illustrating a first selection screen.

FIG. 18 is a diagram illustrating a permission code scan screen.

FIG. 19 is a flowchart of cart terminal processing.

FIG. 20 is a flowchart of cart terminal processing.

FIG. 21 is a flowchart of cart POS processing.

FIG. 22 is a diagram illustrating a first request screen.

FIG. 23 is a diagram illustrating a second request screen.

FIG. 24 is a diagram illustrating a takeover screen.

FIG. 25 is a diagram illustrating a modification of user terminal processing.

FIG. 26 is a diagram illustrating a change example of data record content included in a store database.

### DETAILED DESCRIPTION

An object of embodiments is to provide a transaction processing apparatus, a commodity sales system, and an information processing program that can restrict use during specific time periods within business hours of a store.

According to one embodiment, a transaction processing apparatus includes a communication interface to connect to a communication network, a storage unit for storing a store database with setting information indicating a service available period for a store, and a processor. The processor is configured to receive a registration start instruction via the communication interface from a terminal apparatus operated by a user in the store, determine whether the registration start instruction has been received in the service available period for the store by reference to the stored setting information for the store, and then permit the user of the terminal apparatus to register a commodity designated using the terminal apparatus in a sales transaction only if the registration start instruction was received in the service available period for the store.

Certain example embodiments are explained below with reference to the drawings.

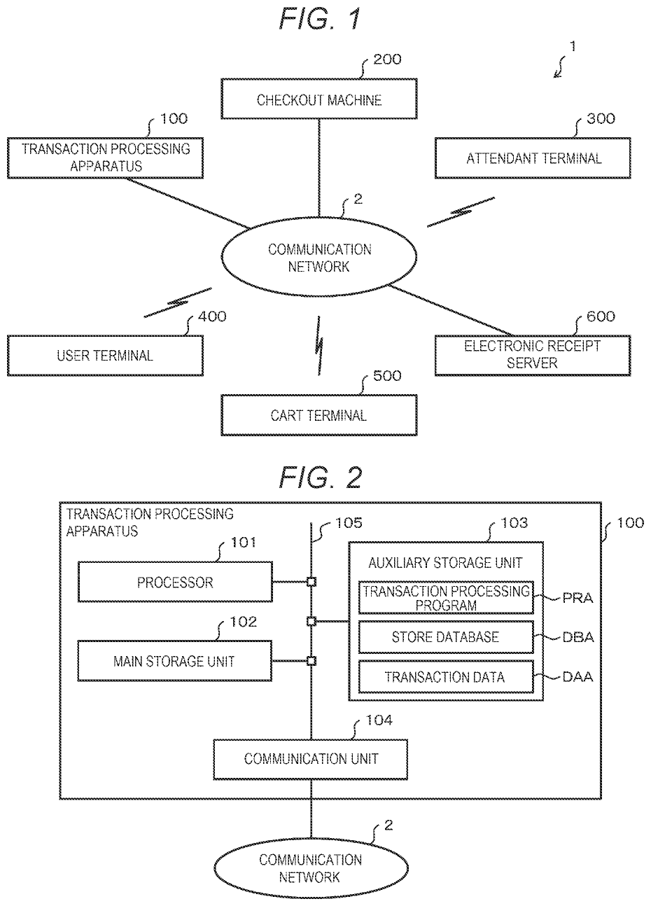

FIG. 1 is a block diagram illustrating a schematic configuration of a transaction processing system 1 according to an example embodiment.

The transaction processing system 1 is configured to enable a transaction processing apparatus 100, a checkout machine 200, an attendant terminal 300, a user terminal 400, a cart terminal 500, and an electronic receipt server 600 to communicate via a communication network 2.

As the communication network 2, the Internet, a VPN (virtual private network), a LAN (local area network), a public communication network, a mobile communication network, and the like can be used alone or can be used in combination as appropriate. As an example of the communication network 2, the Internet and the mobile communication network are used in combination.

Any number of transaction processing apparatuses 100, checkout machines 200, attendant terminals 300, user terminals 400, and cart terminals 500 may be respectively included in the transaction processing system 1. However, in FIG. 1, only one processing apparatus 100, one checkout machine 200, one attendant terminal 300, one user terminal 400, and one cart terminal 500 are illustrated.

The transaction processing apparatus 100 is an information processing apparatus that performs information processing for providing a transaction processing service for processing commodity sales transactions between a user and a store according to operations that the user performs while moving around a selling floor (sales floor) using a user terminal 400 or a cart terminal 500 as a terminal apparatus for a user interface. In some instances, a checkout machine 200 may also or instead function as a terminal apparatus. That is, typically, the customer who purchases commodities in the store is the user of the transaction processing service. The transaction processing apparatus 100 is implemented as, for example, a cloud server and provides the transaction processing service in a plurality of stores. In some examples, the transaction processing apparatus 100 may be implemented as, for example, a local server and provide the transaction processing service only in one store. The transaction processing service is an example of a commodity sales system because the transaction processing service processes the commodity sales transaction.

The checkout machine 200 is installed in the store and executes checkout processing relating to settlement (payment) of a transaction processed by the transaction processing apparatus 100. In the checkout processing, the checkout machine 200 receives operations from an operator. That is, the checkout machine 200 is a terminal apparatus that receives operations of a user relating to the checkout (settlement). The operator of the checkout machine 200 is mainly the customer, but a store clerk may sometimes be the operator of the checkout machine 200.

The attendant terminal 300 is an information processing terminal operated by the store clerk. The attendant terminal 300 is a terminal apparatus for a user interface concerning information processing for supporting work of the store clerk concerning a transaction processed by the transaction processing system 1.

The user terminal 400 is an information processing terminal carried by the user. The user terminal 400 is typically owned by the user and carried into the store and used by just the user. The user terminal 400 is a terminal apparatus that receives operations of the user for transaction processing in the transaction processing apparatus 100.

The cart terminal 500 is an information processing terminal attached to a shopping cart equipped in the store. The cart terminal 500 is lent to the user together with the shopping cart. The cart terminal 500 is a terminal apparatus that receives operations of the user for transaction processing in the transaction processing apparatus 100. The cart terminal 500 may include an information communication terminal lent to the user from the store and carried and used by the user.

The electronic receipt server 600 is an information processing apparatus that performs information processing for providing an electronic receipt service to the user. The electronic receipt server 600 is implemented as, for example, a Cloud server and provides an electronic receipt service for enabling transactions in a plurality of stores to be electronically viewed. The transaction processing apparatus 100 may be implemented as, for example, a local server and provide an electronic receipt service for enabling a transaction only in one store to be electronically viewed.

FIG. 2 is a block diagram of the transaction processing apparatus 100.

The transaction processing apparatus 100 includes a processor 101, a main storage unit 102, an auxiliary storage unit 103, a communication unit 104, and a transmission line 105. The processor 101 and the main storage unit 102, the auxiliary storage unit 103, and the communication unit 104 are enabled to communicate via the transmission line 105.

The transaction processing apparatus 100 can be a computer configured by connecting the processor 101, the main storage unit 102, and the auxiliary storage unit 103 via the transmission line 105.

The processor 101 executes, according to an operating system and information processing programs such as application programs, information processing for controlling the units in order to realize various functions of the transaction processing apparatus 100.

The main storage unit 102 includes a read-only memory region and a rewritable memory region. The main storage unit 102 stores a part of the information processing programs in the read-only memory region. The main storage unit 102 sometimes stores data necessary for the processor 101 in executing processing for controlling the units in the read-only memory region or the rewritable memory region. The main storage unit 102 uses the rewritable memory region as a work area by the processor 101.

As the auxiliary storage unit 103, an EEPROM (electric erasable programmable read-only memory), a HDD (hard disc drive), an SSD (solid-state drive), or other well-known various storage devices can be used. The auxiliary storage unit 103 stores data used by the processor 101 in performing various kinds of processing and data generated by the processing in the processor 101. The auxiliary storage unit 103 sometimes stores information processing programs. In this embodiment, the auxiliary storage unit 103 stores a transaction processing program PRA that is one of the information processing programs. The transaction processing program PRA is an application program. A part of a storage region of the auxiliary storage unit 103 is used as a region for storing a store database DBA and transaction data DAA. The store database DBA is a database for managing a store that provides a transaction processing service by the transaction processing apparatus 100. The transaction data DAA is data representing content of each transaction.

The communication unit 104 executes communication processing for performing data communication via the communication network 2. As the communication unit 104, for example, an existing wired communication device for the Internet can be used. As the communication unit 104, a wireless communication device connected to the communication network 2 by wireless communication may be used instead of or in addition to the wired communication device.

The transmission line 105 includes an address bus, a data bus, and a control signal line and transmits data and control signals transmitted and received among the connected units.

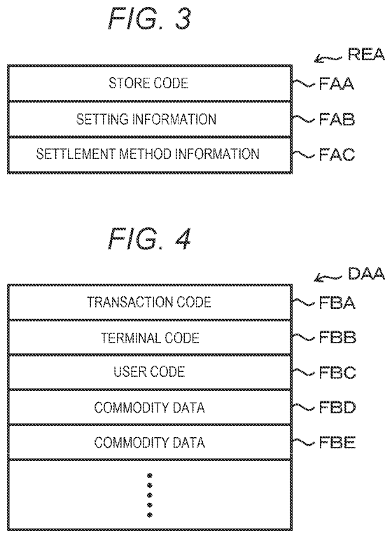

FIG. 3 is a diagram schematically illustrating a configuration of one data record REA included in the store database DBA.

The store database DBA has data records REA for each of the stores providing the transaction processing service with the transaction processing apparatus 100.

A data record REA for a store includes fields FAA, FAB, and FAC. In the field FAA, a store code serving as an identifier for identifying the particular store corresponding to the data record REA is set. In the field FAB, various kinds of setting information associated with providing the transaction processing service in the particular store are set. That is, the setting information is information representing settings for providing the transaction processing service in the particular store. In this context, the setting information includes, for example, information indicating a time period (the “use available time period”) during which the transaction processing service is available in the store to be used by customers and the like. In the field FAC, settlement method information indicating, for example, a total price for a transaction being processed by the transaction processing service that can be settled using an online settlement service is set. If the same setting information is applied to a plurality of stores operated by the same company, a company code for identifying the company may be set in the field FAA instead of an individual store code. If the same store code can be used in different companies, company codes and the store code may both be set in the field FAA.

The various kinds of setting information set in the field FAB are updated as appropriate by the processor 101, for example, in response to an instruction from an information terminal via the communication network 2 by a store administrator or the like.

FIG. 4 is a diagram schematically illustrating a configuration of the transaction data DAA.

The transaction data DAA is generated for each of the transactions being processed by the transaction processing apparatus 100. The transaction data DAA is stored in the auxiliary storage unit 103. Therefore, no transaction data DAA is stored in the auxiliary storage unit 103 in some cases or a plurality of transaction data DAA can be simultaneously stored in the auxiliary storage unit 103 in other cases.

The transaction data DAA includes fields FBA, FBB, FBC, and FBD (plus additional fields as necessary). The transaction data DAA can include any number of fields following field FBD. In the field FBA, a transaction code serving as an identifier of the particular transaction of concern is set. In the field FBB, a terminal code serving as an identifier of the user terminal 400 or the cart terminal 500 being used by a user who performs the transaction is set. In the field FBC, a user code serving as an identifier of the user who performs the transaction is set. If there are registered commodities (hereinafter referred to as transaction commodities) as targets of the transaction, fields FBD, FBE, etc., each respectively correlated with a transaction commodity are added to the transaction data DAA. In the fields FBD, FBE, etc., commodity data concerning different transaction commodities are respectively set. The commodity data entry includes commodity codes serving as identifiers and a numerical value indicating a quantity of the transaction commodity. The commodity data may include other various kinds of information such as a commodity name, a unit price, and discount information.

For example, a general-purpose server apparatus can be used as hardware of the transaction processing apparatus 100. In general, the transaction processing apparatus 100 is transferred with the transaction processing program PRA stored in the auxiliary storage unit 103 but without the store database DBA and the transaction data DAA in the auxiliary storage unit 103. However, the hardware and the transaction processing program PRA may be separately transferred. The hardware with an application program of the same general type as the transaction processing program PRA but a different version or the like may be stored in the auxiliary storage unit 103 at an initial transfer, then the transaction processing program PRA may be added, or the existing program may be updated to correspond to the transaction processing program PRA. The transaction processing program PRA may be written in the auxiliary storage unit 103 according to operation of any operator. The transaction processing program PRA can be transferred by being recorded in a removable recording medium such as a magnetic disk, a magnetooptical disk, an optical disk, or a semiconductor memory or by communication via a network.

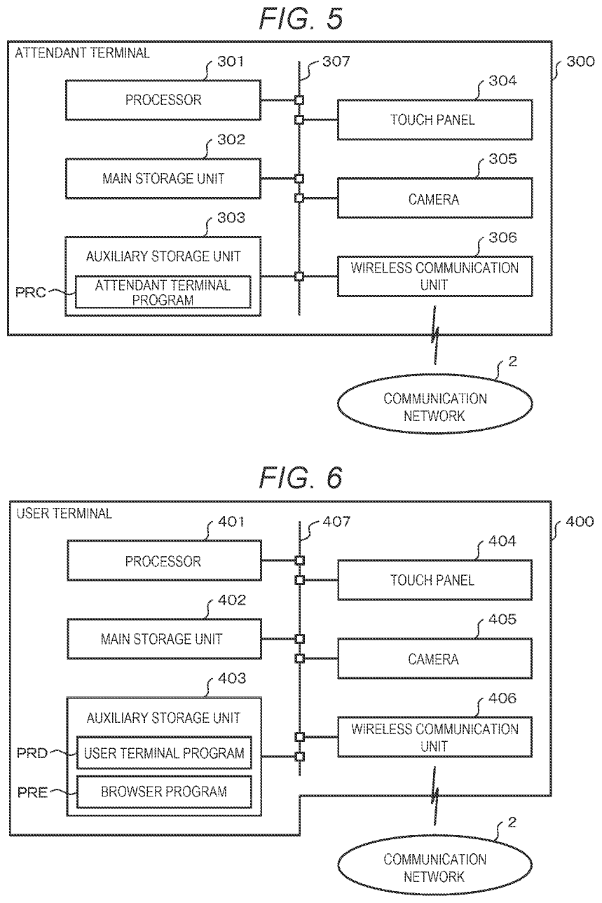

FIG. 5 is a block diagram of the attendant terminal 300.

The attendant terminal 300 includes a processor 301, a main storage unit 302, an auxiliary storage unit 303, a touch panel 304, a camera 305, a wireless communication unit 306, and a transmission line 307.

Basic functions and aspects of the processor 301, the main storage unit 302, the auxiliary storage unit 303, and the transmission line 307 are in general equivalent to those of the processor 101, the main storage unit 102, the auxiliary storage unit 103, and the transmission line 105. However, the auxiliary storage unit 303 stores an attendant terminal program PRC instead of the transaction processing program PRA. The attendant terminal program PRC is an application program describing a procedure of information processing of the processor 301 for causing the attendant terminal 300 to operate as a user interface for a store clerk for supporting a transaction processed by the transaction processing apparatus 100.

The touch panel 304 displays a screen for presenting information to the operator. An instruction by touch operation on the screen by the operator is input to the touch panel 304.

The camera 305 includes an optical system and an image sensor and generates, with the image sensor, image data representing an image in a visual field formed by the optical system.

The wireless communication unit 306 executes communication processing for performing data communication via the communication network 2. As the wireless communication unit 306, for example, an existing wireless communication device for a wireless LAN can be used. A communication unit connected to the communication network 2 by wire may be used instead of or in addition to the wireless communication unit 306.

As hardware of the attendant terminal 300, for example, a tablet type information processing apparatus or a portable information processing apparatus such as a smartphone can be used. As the hardware of the attendant terminal 300, a stationary computer apparatus may be used.

FIG. 6 is a block diagram of the user terminal 400.

The user terminal 400 includes a processor 401, a main storage unit 402, an auxiliary storage unit 403, a touch panel 404, a camera 405, a wireless communication unit 406, and a transmission line 407.

Basic functions and aspects of the processor 401, the main storage unit 402, the auxiliary storage unit 403, and the transmission line 407 are equivalent to those of the processor 101, the main storage unit 102, the auxiliary storage unit 103, and the transmission line 105. Functions of the touch panel 404, the camera 405, and the wireless communication unit 406 are generally equivalent to those of the touch panel 304, the camera 305, and the wireless communication unit 306. However, the auxiliary storage unit 403 stores a user terminal program PRD instead of the transaction processing program PRA. The user terminal program PRD is an application program describing a procedure of information processing of the processor 401 for causing the user terminal 400 to operate as a user interface for transaction processing by the transaction processing apparatus 100. The auxiliary storage unit 403 stores a browser program PRE. The browser program PRE is an application program describing a procedure of information processing for Web browsing via the communication network 2. As the browser program PRE, a general-purpose browser application included in a smartphone or the like as standard can be directly used. The wireless communication unit 406 typically includes a well-known communication device for performing data communication via a mobile communication network. However, the wireless communication unit 406 may include an existing wireless communication device for a wireless LAN instead of or in addition to the communication device.

It is assumed that, for example, hardware of a smartphone is used as basic hardware of the user terminal 400.

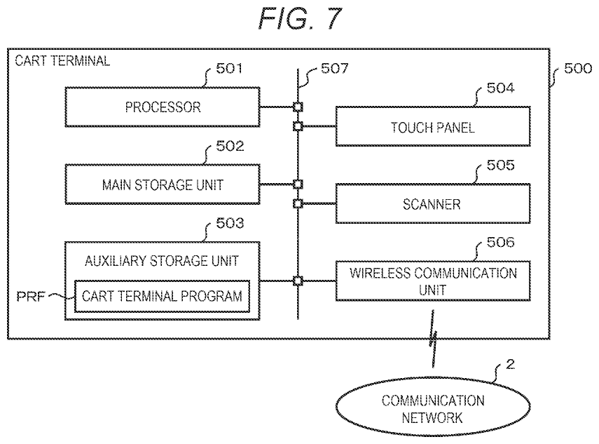

FIG. 7 is a block diagram of the cart terminal 500.

The cart terminal 500 includes a processor 501, a main storage unit 502, an auxiliary storage unit 503, a touch panel 504, a scanner 505, a wireless communication unit 506, and a transmission line 507.

The functions of the processor 501, the main storage unit 502, the auxiliary storage unit 503, and the transmission line 507 are generally equivalent to those of the processor 101, the main storage unit 102, the auxiliary storage unit 103, and the transmission line 105. The functions of the touch panel 504 and the wireless communication unit 506 are generally equivalent to those of the touch panel 304 and the wireless communication unit 306. However, the auxiliary storage unit 503 stores a cart terminal program PRF instead of the transaction processing program PRA. The cart terminal program PRF is an application program describing a procedure of information processing of the processor 501 for causing the cart terminal 500 to operate as a user interface for transaction processing by the transaction processing apparatus 100. The wireless communication unit 506 typically includes an existing wireless communication device for a wireless LAN. However, the wireless communication unit 506 may include a well-known communication device for performing data communication via a mobile communication network instead of or in addition to the communication device.

The scanner 505 optically scans a one-dimensional barcode, a two-dimensional barcode, or the like.

It is assumed that hardware of a tablet type information processing apparatus is used as basic hardware of the cart terminal 500. It is also assumed that a scanner is a separate unit from the information processing apparatus and is externally attached to the information processing apparatus as the scanner 505. However, the cart terminal 500 may use, as an imaging device of the scanner 505, a camera incorporated in the information processing apparatus.

An operation of the transaction processing system 1 is explained. In the description, the specific content of the various processing explained are examples. Similarly, a change of order of some of the processing, omission of a part of the processing, addition of other processing, or the like is possible. In the following, specific explanation about certain processing may be omitted in order to focus description on characteristic operations of this embodiment. For example, if some error occurs, the processing for coping with the error may be performed. However, the specific description about such processing may be omitted.

A service provided to the user by the transaction processing system 1 is called smartphone POS service if the user uses the user terminal 400 and cart POS service if the user uses the cart terminal 500.

In order to use the smartphone POS service, the user installs the user terminal program PRD in an information processing apparatus such as a smartphone owned by the user to make it possible to use the information processing apparatus as the user terminal 400. Then, the user enters the store where the smartphone POS service is provided while carrying the user terminal 400, according to the user terminal program PRD, that is in a state in which the processor 401 is executing user terminal processing.

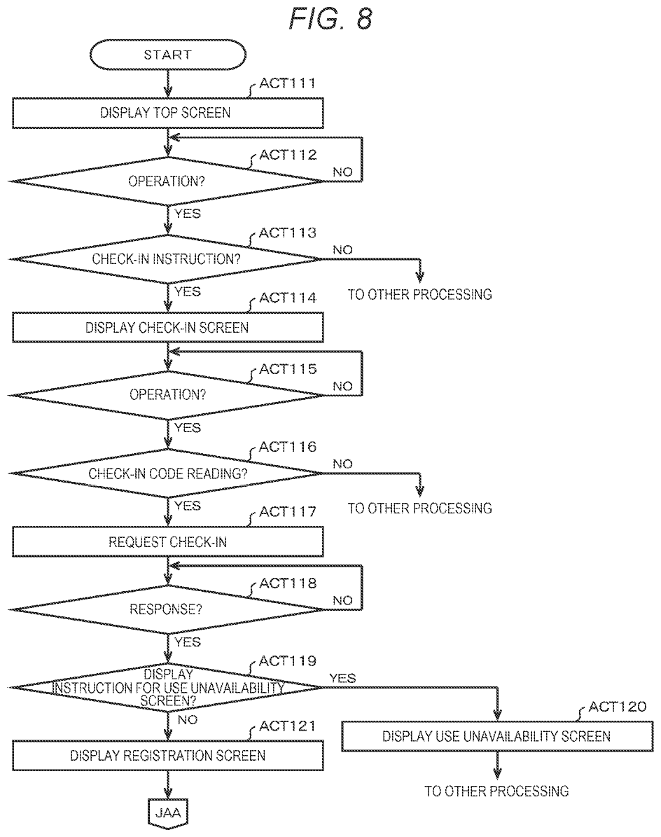

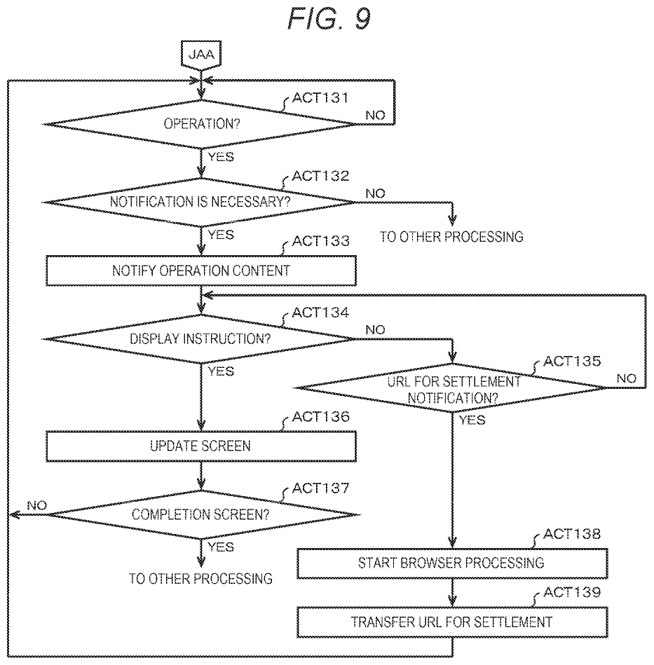

FIGS. 8 and 9 are flowcharts of the user terminal processing.

In ACT 111, the processor 401 causes the touch panel 404 to display a top screen. The top screen is a screen for causing the user to designate a function that should be executed out of various functions realized by the user terminal processing. The top screen displays a softkey for receiving a check-in instruction.

In the store where the smartphone POS service is provided, a check-in code representing check-in data is posted at an entrance of the store, in the store, or the like. The check-in code is, for example, a two-dimensional barcode. The check-in data includes at least a store code. Therefore, the check-in code is different for each store.

When the user is about to start to use the smartphone POS service in the store, the user performs an operation such as tapping a softkey displayed on the top screen in order to receive the check-in instruction.

In ACT 112, the processor 401 waits for some operation by the user to be performed in a state in which the top screen is displayed. If an operation by the user is detected by the touch panel 404, the processor 401 determines YES and proceeds to ACT 113.

In ACT 113, the processor 401 checks whether the performed operation is an operation for the check-in instruction. If not, the processor 101 determines NO, checks content of the operation, and proceeds to other processing for performing processing corresponding to the content of the operation. As one kind of the other processing, for example, the processor 101 confirms that operation for instructing a stop was performed, cancels a check-in procedure, and performs the processing from ACT 111 again. As the other processing, another kind of processing or a plurality of kinds of processing are sometimes selectively performed. However, detailed explanation of the processing is omitted here.

If the operation for the check-in instruction was performed, the processor 401 determines YES in ACT 113 and proceeds to ACT 114.

In ACT 114, the processor 401 causes the touch panel 404 to display a check-in screen. The check-in screen is a screen for guiding the user to cause the camera 405 of the user terminal 400 to image the check-in code.

In ACT 115, the processor 401 waits for some operation by the user to be performed. If the operation by the user was performed, the processor 401 proceeds to ACT 116.

The user operates the user terminal 400 according to the check-in screen and causes the camera 405 of the user terminal 400 to image the check-in code posted in the store that the user uses. The operation of the user terminal 400 by the user at this time is an example of operation for starting registering a transaction commodity concerning a transaction using the smartphone POS service.

If a two-dimensional barcode was imaged by the camera 405, the processor 401 considers that operation for causing the user terminal 400 to read the two-dimensional barcode was performed, determines YES in ACT 115, and proceeds to ACT 116.

In ACT 116, the processor 401 checks whether the check-in code was read. If not, the processor 401 checks content of the operation and proceeds to other processing for performing processing corresponding to the content of the operation. As one kind of the other processing, for example, the processor 401 confirms that, although the operation for causing the user terminal 400 to read the two-dimensional barcode was performed, the two-dimensional barcode is not the check-in code and displays a screen for notifying such an operation error to the user. As the other processing, another kind of processing or a plurality of kinds of processing are sometimes selectively performed. However, detailed explanation of the processing is omitted here.

If the check-in code was imaged by the camera 405, the processor 401 considers that the check-in code was read, determines YES in ACT 116 and proceeds to ACT 117.

In ACT 117, the processor 401 transmits a check-in request to the transaction processing apparatus 100. For example, the processor 401 delivers request data for the check-in request from the wireless communication unit 406 to the communication network 2 while addressing the request data to the transaction processing apparatus 100. The processor 401 includes, in the request data, the check-in data represented by the check-in code imaged by the camera 405 and the terminal code of the user terminal 400. The terminal code is stored in, for example, the auxiliary storage unit 403. As the terminal code, an identifier determined by the operation system of the user terminal 400 can be used if the user terminal program PRD is installed. The identifier is, for example, a 32-bit code in which alphanumeric characters are mixed.

On the other hand, in order to use the electronic receipt service provided by the electronic receipt server 600, the user performs use registration and receives issuance of a user code in advance. If the user desires to use an online settlement service for settlement of a transaction in which the smartphone POS service is used, the user performs association of a user code of the electronic receipt service in advance as use setting for the user terminal program PRD. With this association, in the user terminal 400, the user code is stored in the main storage unit 402 or the auxiliary storage unit 403 in a state in which the processor 401 is accessible in the user terminal processing. If the user code is stored, the processor 401 includes the user code in the request data as well.

If the request data for the request for check-in is transmitted to the transaction processing apparatus 100 by the communication network 2, the communication unit 104 receives the request data and temporarily stores the request data in the main storage unit 102 or the auxiliary storage unit 103.

If the request data delivered from the user terminal 400 is received by the transaction processing apparatus 100 in which way, the processor 101 starts, according to the transaction processing program PRA, transaction processing for the smartphone POS service (hereinafter referred to as smartphone POS processing).

However, such a check-in procedure is only an example and various changes of the check-in procedure are possible. For example, after the user terminal program PRD is started, the processor 401 of the user terminal 400 may transmit check-in data including position information acquired using a GPS (global positioning system), another positioning sensor, or the like to the transaction processing apparatus 100. For example, upon receiving the position information, the transaction processing apparatus 100 may acquire, from a database including setting information in correlation with position information, setting information of a store where the user terminal 400 that transmitted the position information is located and perform check-in processing according to the setting information.

If the processor 101 was already executing smartphone POS processing for a transaction concerning a different user, the processor 101 starts a new smartphone POS processing as processing of a thread different from the smartphone POS processing. That is, the processor 101 sometimes executes a plurality of smartphone POS processing in parallel. In this case, a plurality of user terminals 400 to be used as user interface terminals of the transaction processing apparatus 100 are simultaneously present. However, in the following explanation, only processing of a transaction concerning one user is focused upon. Therefore, “user terminal 400” in the following explanation indicates one user terminal 400 being used by the user for the focused smartphone POS processing. “Transaction” in the following explanation indicates a target transaction of the focused processing.

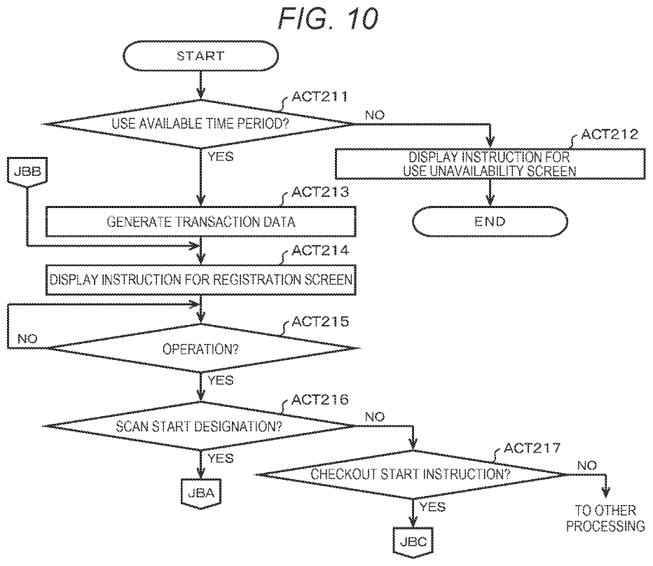

FIGS. 10, 11, and 12 are flowcharts of the smartphone POS processing. In the following explanation, an example is explained in which a check-in code is read by the user terminal 400 and a store code is included in check-in data represented by the check-in code.

In ACT 211 in FIG. 10, the processor 101 checks whether a present point in time is within the use available time period. That is, for example, the processor 101 finds out, from the store database DBA, the data record REA in which a store code included in received check-in data is set in the field FAA and determines a use available time period represented by information included in the setting information set in the field FAB of the data record REA. For example, if the present point in time is not included in the determined use available time period, the processor 101 determines NO and proceeds to ACT 212. The use available time period may be decided as appropriate for each store.

In ACT 212, the processor 101 instructs the user terminal 400 to display a use unavailability screen. The use unavailability screen is a screen for causing the user to recognize that the smartphone POS service cannot be used. For example, the processor 101 delivers instruction data for instructing the user terminal 400 to display the use unavailability screen to the communication network 2 from the communication unit 104 while addressing the instruction data to the user terminal 400. Thereafter, the processor 101 ends the smartphone POS processing.

If the instruction data for the screen display instruction is transmitted to the user terminal 400 by the communication network 2, in the user terminal 400, the wireless communication unit 406 receives the instruction data. Upon receiving the instruction data, the wireless communication unit 406 notifies the processor 401 to that effect. When the instruction data for the screen display instruction is received, the processor 401 causes, with the user terminal processing, the touch panel 404 to display a screen corresponding to the instruction data.

The instruction data for the screen display instruction may include screen data representing a screen that should be displayed according to the instruction data. In some examples, instruction data may not include such specific screen data but may include data for enabling the user terminal 400 to identify the screen that should be displayed. In the former case, for example, the processor 101 generates screen data representing a screen to be displayed on the user terminal 400 and then includes the screen data in the instruction data. In the latter case, for example, the processor 101 includes, in the instruction data, a screen identifier preset as an identifier for identifying a screen to be displayed on the user terminal 400 or a notification identifier for identifying notification serving as an opportunity for the screen display. The notification identifier is, for example, information preset to identify, for example, notification “outside a use available time period”.

In the user terminal 400, after requesting the check-in in ACT 117 in FIG. 8, the processor 401 proceeds to ACT 118.

In ACT 118, the processor 401 waits for a response to the check-in request. If instruction data for instructing to display some screen is received by the wireless communication unit 406, the processor 401 considers that a response was performed, determines YES, and proceeds to ACT 119.

In ACT 119, the processor 401 checks whether the use unavailability screen was instructed to be displayed. If the use unavailability screen was instructed to be displayed, the processor 401 determines YES and proceeds to ACT 120.

In ACT 120, the processor 401 causes the touch panel 404 to display the use unavailability screen.

If screen data is included in the received instruction data, the processor 401 causes the touch panel 404 to directly display a screen represented by the screen data. If a screen identifier is included in the received instruction data, the processor 401 generates a screen identified by the screen identifier and causes the touch panel 404 to display the screen. If a notification identifier is included in the received instruction data, the processor 401 determines a screen that should be displayed according to notification identified by the notification identifier, generates the screen, and causes the touch panel 404 to display the screen.

Transmission and reception of display instructions for various screens for the following can be performed by the same procedure as already explained above, although specific contents of screens to be display may be different.

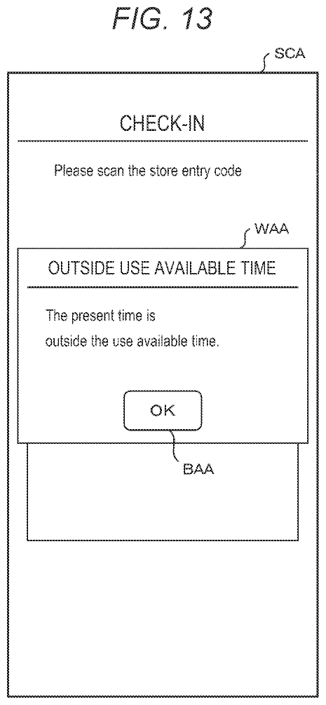

FIG. 13 is a diagram illustrating a use unavailability screen SCA.

The use unavailability screen SCA is a screen in which a popup window WAA is displayed over a screen displayed on the touch panel 404 in a state in which a check-in code is scanned. The popup window WAA displays a character message for informing the user that present point in time is outside the use available time period and a button BAA. The button BAA is a softkey for receiving an expression by the user that the information on the use unavailability screen SCA was confirmed.

The processor 101 causes the user terminal 400 to display such a use unavailability screen SCA to notify the user that a transaction commodity cannot be started to be registered using the smartphone POS service because the present point in time is outside the use available time period. The processor 101 executes the smartphone POS processing based on the transaction processing program PRA to provide functions of a communication unit.

If confirming the information on the use unavailable screen SCA, the user taps the button BAA. If such operation is detected on the touch panel 404, the processor 401 ends displaying the use unavailability screen SCA and restores the display screen of the touch panel 404 to, for example, the screen for scanning the check-in code.

On the other hand, if the present point in time is included in the use available time period, the processor 101 determines YES in ACT 211 in FIG. 10 and proceeds to ACT 213. Thereafter, the processor 101 executes processing for registering a transaction commodity. The processor 101 executes information processing based on the transaction processing program PRA to provide functions of a control unit.

In ACT 213, the processor 101 generates new transaction data. That is, for example, the processor 101 determines, according to a predetermined rule, a new transaction code different from transaction codes for identifying other transactions, generates new transaction data DAA in which the transaction code is set in the field FBA and the terminal code received together with the check-in data is set in the field FBB, and causes the auxiliary storage unit 103 to store the transaction data DAA. If a user code was received together with the check-in data, the processor 101 sets the user code in the field FBC of the transaction data DAA. If a user code was not received together with the check-in data, the processor 101 sets the field FBC of the transaction data DAA in a null state.

In ACT 214 in FIG. 10, the processor 101 instructs the user terminal 400 to display a registration screen as a response to the check-in request. The registration screen includes, for example, a list of registered commodities as transaction commodities and is a screen for causing the user to recognize a registration state of the transaction commodities. For example, the processor 101 generates screen data representing the registration screen reflecting the registration state of the transaction commodities and includes the screen data in instruction data for instructing the user terminal 400 to perform screen display. The processor 101 may not include the screen data in the instruction data but may include a screen identifier of the registration screen or a notification identifier for identifying notification “check-in confirmation is completed” in the instruction data. The processor 401 may generate the registration screen in the user terminal 400.

In the user terminal 400, if determining YES in ACT 118 in FIG. 8 according to the reception of the instruction data for the display instruction for the registration screen and proceeding to ACT 119, the processor 401 determines NO because the display instruction is not a display instruction for the use unavailability screen and proceeds to ACT 121.

In ACT 121, the processor 401 causes the touch panel 404 to display the registration screen.

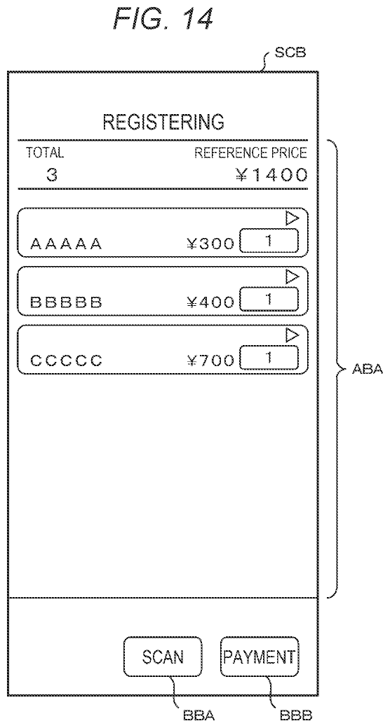

FIG. 14 is a diagram illustrating a registration screen SCB.

In the registration screen SCB, an image showing a registration state is arranged in a display area ABA. The registration screen SCB displays buttons BBA and BBB. In an example illustrated in FIG. 14, the image arranged in the display area ABA shows a state in which one article of each of and three articles in total of commodities respectively having commodity names “AAAAA”, “BBBBB”, and “CCCCC” and unit prices of 300 yen, 400 yen, and 700 yen were registered and a reference price of the commodities is 1400 yen. The reference price is an amount calculated by subtracting a price-cut amount by various services such as a coupon service from a sum of unit prices of all transaction commodities. If a transaction is settled without transaction commodities and services applied thereto being changed, the reference price is a settlement amount. The image arranged in the display area ABA sequentially changes according to a registration state of transaction commodities. If the processor 101 executes ACT 214 in FIG. 10 first, transaction commodities are not registered yet. Therefore, on the registration screen SCB represented by image data transmitted to the user terminal 400 by the processor 101 executing the ACT 213 in FIG. 10 first, the image arranged in the display area ABA is an image not representing information concerning commodities but indicating that a total number of articles is 0 and a reference price is 0 yen.

The button BBA is a softkey for receiving a shift instruction to a state in which a new commodity is scanned. The button BBB is a softkey for receiving an instruction for a checkout start. In some cases, on the registration screen SCB and various screens explained below, main display objects are illustrated and illustration of a part of display objects is omitted. For example, an image for suggesting operation that the user should perform is sometimes included in the screen. The registration screen SCB and the various screens explained below are examples and may be decided as appropriate by, for example, a creator of the transaction processing program PRA.

After causing the touch panel 404 to display the registration screen SCB, the processor 401 proceeds to ACT 131 in FIG. 9.

In ACT 131, the processor 401 waits for some operation by the user to be performed. If the operation is detected by the touch panel 404, the processor 401 determines YES and proceeds to ACT 132.

In ACT 132, the processor 401 checks whether it is necessary to notify the performed operation to the transaction processing apparatus 100. If the performed operation is not a target of notification, the processor 401 determines NO, checks content of the operation, and proceeds to other processing corresponding to the content of the operation. As one kind of such other processing, for example, the processor 401 scrolls the registration screen according to a scroll operation. As other processing, another kind of processing or a plurality of kinds of processing may be selectively performed. However, explanation of details of such processing is omitted here.

On the other hand, if the performed operation is a target of notification, the processor 401 determines YES in ACT 132 and proceeds to ACT 133.

In ACT 133, the processor 401 notifies operation content to the transaction processing apparatus 100. For example, the processor 401 delivers notification data for notifying the operation content to the communication network 2 while addressing the notification data from the wireless communication unit 406 to the transaction processing apparatus 100.

When the notification data for notifying the operation content is transmitted to the transaction processing apparatus 100 by the communication network 2, in the transaction processing apparatus 100, the communication unit 104 receives the notification data. Upon receiving the notification data, the communication unit 104 notifies the processor 101 to that effect.

Transmission and reception of notification of operation contents concerning various screens to be explained below can be performed by the same procedure as already explained above although contents of operation may be different.

In ACT 215 in FIG. 10, the processor 101 waits for operation to be performed in the user terminal 400. If it is notified from the communication unit 104 that the notification data for notifying the operation content was received, the processor 101 determines YES and proceeds to ACT 216.

In ACT 216, the processor 101 checks whether the performed operation is an operation for designating a scan start. If not, the processor 101 determines NO and proceeds to ACT 217.

In ACT 217, the processor 101 checks whether the performed operation is an operation for designating a checkout start. If not, the processor 101 determines NO, checks content of the operation, and proceeds to other processing for performing processing corresponding to the content of the operation. As one kind of other processing, the processor 101 confirms that operation for designating a transaction stop was performed and ends the registration processing after executing processing for stopping the transaction.

The user searches for a commodity to be purchased in the store. That is, the user shops for one or more items in the store. When the user registers a commodity for purchase, the user performs a predetermined operation for designating a scan start, for example, operation of tapping the button BBA on the registration screen SCB. This operation is a notification target. In the user terminal 400, the processor 401 determines YES in both of ACT 131 and ACT 132 in FIG. 9, proceeds to ACT 133, and transmits notification data for notifying the operation for the scan start instruction.

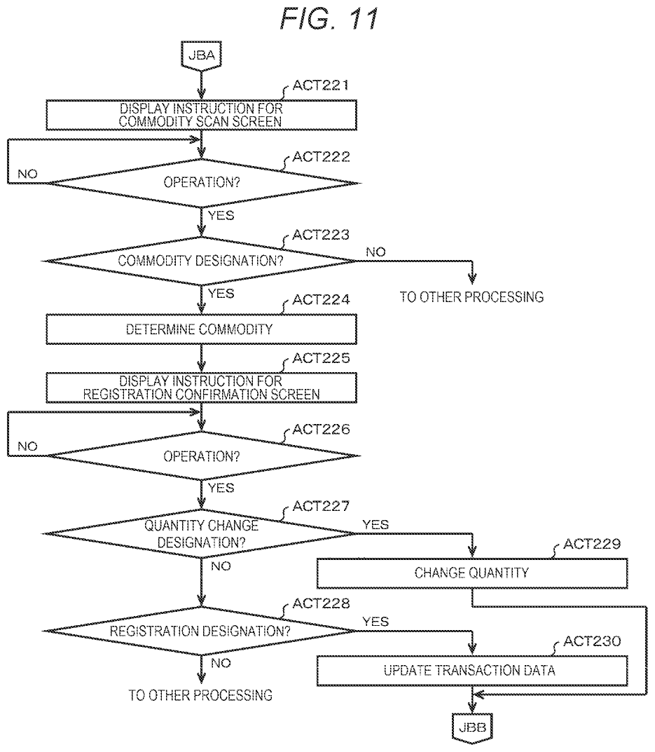

If the operation for the scan start instruction is notified from the user terminal 400 to the transaction processing apparatus 100, the processor 101 determines YES in ACT 216 in FIG. 10 and proceeds to ACT 221 in FIG. 11.

In ACT 221, the processor 101 instructs the user terminal 400 to display a commodity scan screen. The commodity scan screen is a screen for scanning a barcode representing a commodity code.

In the user terminal 400, the processor 401 proceeds to ACT 134 after notifying the operation content in ACT 133 in FIG. 9.

In ACT 134, the processor 401 checks whether a display instruction was performed. If not, the processor 401 determines NO and proceeds to ACT 135.

In ACT 135, the processor 401 checks whether a URL for settlement was notified. If not, the processor 401 determines NO and returns to ACT 134.

In this way, in ACT 134 and ACT 135, the processor 401 waits for notification of the display instruction or the URL for settlement.

If instruction data for instructing to display some screen is transmitted from the transaction processing apparatus 100 and is received by the wireless communication unit 406, the processor 401 determines YES in ACT 134 and proceeds to ACT 136.

In ACT 136, the processor 401 updates the display screen on the touch panel 404 according to the instruction. That is, the processor 401 updates the display screen on the touch panel 404 to the commodity scan screen according to the display instruction for the commodity scan screen.

In ACT 137, the processor 401 checks whether the display screen after the update is a completion screen. As in the case in which the display screen is updated to the commodity scan screen, if the display screen was updated to a screen other than the completion screen, the processor 401 determines NO and returns to the waiting state in ACT 131. That is, the processor 401 shifts to a state for waiting for operation concerning the screen after the update.

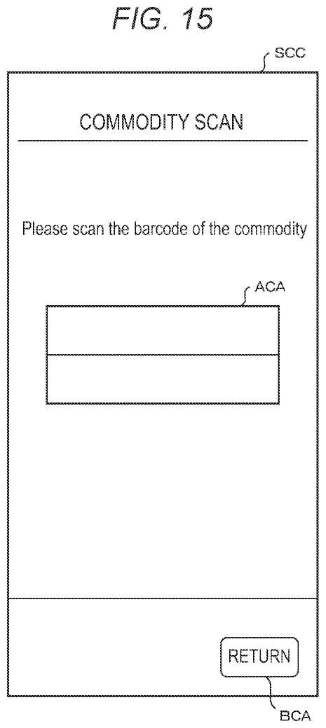

FIG. 15 is a diagram illustrating a commodity scan screen SCC.

The commodity scan screen SCC includes a display area ACA and a button BCA. The display area ACA is an area for displaying an image obtained by the camera 405. The button BCA is a softkey for the user to declare to stop scanning a commodity code.

In the user terminal 400, in displaying the commodity scan screen SCC, the processor 401 starts the camera 405 to thereby superimpose and display an image obtained by the camera 405 in the display area ACA. If the predetermined operation for designating a scan start is performed, the processor 401 may generate a commodity scan screen and cause the touch panel 404 to display the commodity scan screen without notifying the operation to the transaction processing apparatus 100. In this case, in ACT 216, the processor 101 performs processing of ACT 223. Thus, in such a case, upon determining YES in ACT 216, the processor 101 proceeds to ACT 224 without performing ACT 221 to ACT 223.

When the commodity scan screen SCC is displayed on the touch panel 404, the user operates the user terminal 400 such that a barcode displayed on a commodity to be registered as a transaction commodity is reflected in the display area ACA. The processor 401 analyzes the image obtained by the camera 405 and attempts to read the barcode. If the barcode is successfully read, this operation is a notification target. The processor 401 determines YES in both of ACT 131 and ACT 132 in FIG. 9, proceeds to ACT 133, and notifies the transaction processing apparatus 100 that the scan operation was performed (commodity scan notification). Notification data corresponding to the read barcode (barcode data) may be included.

When the user previously cancelled registering of a transaction commodity but then attempts to check a registration state of the transaction commodity, the user performs a predetermined operation for designating a scan stop, for example, tapping the button BCA. This operation is a notification target. The processor 401 determines YES in both of ACT 131 and ACT 132 in FIG. 9, proceeds to ACT 133, and notifies the transaction processing apparatus 100 that the operation for instructing the scan stop was performed.

In the transaction processing apparatus 100, after finishing instructing the commodity scan screen to be displayed in ACT 221 in FIG. 11, the processor 101 proceeds to ACT 222.

In ACT 222, the processor 101 waits for operation to be performed in the user terminal 400. If operation content is notified from the user terminal 400, the processor 101 determines YES and proceeds to ACT 223.

In ACT 223, the processor 101 checks whether the performed operation is operation for designating a commodity. If not, the processor 101 determines NO, checks content of the operation, and proceeds to other processing in order to perform processing corresponding to the content of the operation. As one kind of the other processing, for example, the processor 101 confirms that operation for designating a scan stop, for example, operation of tapping the button BCA was performed, returns to ACT 214 in FIG. 10, and restores the display surface of the touch panel 404 in the user terminal 400 to the registration screen SCB. As the other processing, another kind of processing or a plurality of kinds of processing are sometimes selectively performed. However, detailed explanation of the processing is omitted here.

The operation for designating the scan stop may not be set as a target of notification from the user terminal 400. In the user terminal 400, the processor 401 may autonomously execute, after determining NO in ACT 132, the processing for restoring the display screen of the touch panel 404 in the user terminal 400 to the registration screen SCB.

If the barcode data was notified and the barcode data represents a commodity code, the processor 101 considers that the operation for designating a commodity was performed, determines YES in ACT 223 and proceeds to ACT 224.

In ACT 224, the processor 101 determines, based on the notified barcode data, the commodity that should be registered as a transaction commodity. That is, for example, the processor 101 extracts a commodity code included in the barcode data and determines a commodity corresponding to the commodity code as a commodity that should be registered as a transaction commodity (hereinafter referred to as candidate commodity). The processor 101 may receive, for example, notification from the user terminal 400 indicating that the operation of tapping a preset button displayed on the touch panel 404 was performed and determine a commodity allocated to the preset button as the candidate commodity. The processor 101 may receive, for example, notification from the user terminal 400 about a commodity code directly input on the touch panel 404 as a numerical value string and determine a commodity identified by the commodity code as the candidate commodity. In this way, a function of an input unit to which a commodity code serving as identification information for identifying a commodity is input is realized by cooperation of the processor 101 and the touch panel 404 or the camera 405.

In ACT 225, the processor 101 instructs the user terminal 400 to display a registration confirmation screen. The registration confirmation screen is a screen for checking whether the candidate commodity is registered as a transaction commodity. The processor 101 may include screen data representing the registration confirmation screen in instruction data for a display instruction for the registration confirmation screen or may cause the processor 401 to generate the registration confirmation screen including data of the candidate commodity in the user terminal 400.

In the user terminal 400, if the instruction data for the display instruction for the registration confirmation screen is received, the processor 401 determines YES in ACT 134 in FIG. 9, proceeds to ACT 136, and updates the display screen of the touch panel 404 to the registration confirmation screen. Since the screen after the update is not the completion screen, the processor 401 determines NO in ACT 137 and returns to the waiting state in ACT 131.

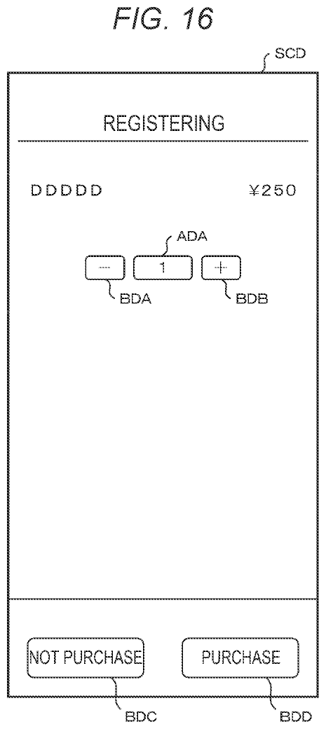

FIG. 16 is a diagram illustrating a registration confirmation screen SCD.

The registration confirmation screen SCD is an example in which the candidate commodity is a commodity having a commodity name “DDDDD” and a unit price of 250 yen. The registration confirmation screen SCD displays a display area ADA and buttons BDA, BDB, BDC and BDD. The display area ADA displays a quantity on the inside. The button BDA is a softkey for receiving designation of a quantity reduction. The button BDB is a softkey for receiving designation of a quantity increase. The button BDC is a softkey for receiving designation that the candidate commodity is not registered as a transaction commodity. The button BDD is a softkey for receiving designation that the candidate commodity is registered as a transaction commodity.

In ACT 226 in FIG. 11, the processor 101 waits for operation to be performed in the user terminal 400. If operation content is notified from the user terminal 400, the processor 101 determines YES and proceeds to ACT 227.

In ACT 227, the processor 101 checks whether a change in a quantity was designated. If not, the processor 101 determines NO and proceeds to ACT 228.

In ACT 228, the processor 101 checks whether designation for registering a candidate commodity as a transaction commodity was performed. If not, the processor 101 determines NO, checks content of the operation, and proceeds to other processing in order to perform processing corresponding to the content of the operation. As one kind of the other processing, the processor 101 confirms that a predetermined operation for designation that registration is stopped, such as tapping the button BDC, was performed and returns to ACT 221.

If desiring to change the quantity, the user designates a quantity change by, for example, tapping the button BDA or the button BDB. This operation is a notification target. In the user terminal 400, the processor 401 determines YES in both of ACT 131 and ACT 132 in FIG. 9, proceeds to ACT 133, and notifies the transaction processing apparatus 100 that the operation for designating the quantity change was performed. According to the notification, the processor 101 determines YES in ACT 227 in FIG. 11 and proceeds to ACT 229.

In ACT 229, the processor 101 updates the transaction data DAA to change the quantity according to the designation. Thereafter, the processor 101 returns to ACT 214 in FIG. 10, instructs the user terminal 400 to display the registration screen SCB corresponding to the transaction data updated as explained above, and then returns to the waiting state in ACT 215.

Upon determining to register the candidate commodity displayed on the registration confirmation screen SCD as a transaction commodity with the quantity displayed in the display area ADA, the user designates the registration with a predetermined operation of, for example, tapping the button BDD. If such operation is notified from the user terminal 400, the processor 101 determines YES in ACT 228 and proceeds to ACT 230.

In ACT 230, the processor 101 registers the candidate commodity as a transaction commodity with the quantity displayed in the display area ADA. For example, the processor 101 updates the transaction data DAA to include commodity data respectively representing a commodity code of the candidate commodity and the quantity displayed in the display area ADA. The processor 101 executes the information processing based on the transaction processing program PRA to provide functions of a registration unit. Thereafter, the processor 101 returns to ACT 214 in FIG. 10, instructs the user terminal 400 to display the registration screen SCB corresponding to the transaction data updated as explained above, and then returns to the waiting state in ACT 215.

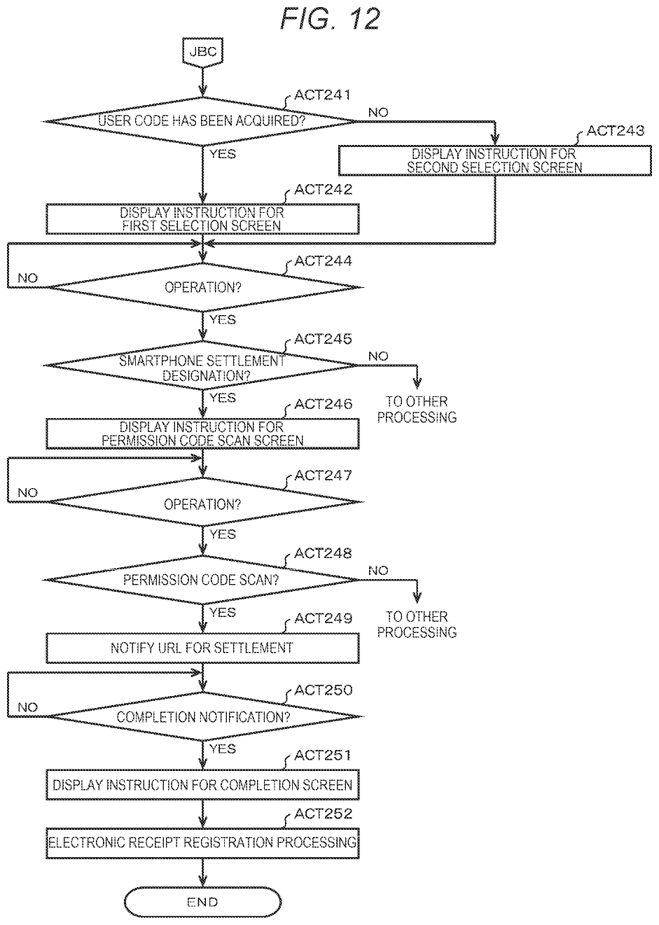

When finished with registering all transaction commodities to be purchased in the present shopping, the user designates a checkout start by, for example, tapping the button BBB in the registration screen SCB. This operation is a notification target. In the user terminal 400, the processor 401 determines YES in both of ACT 131 and ACT 132 in FIG. 9, proceeds to ACT 133, and notifies the transaction processing apparatus 100 that the operation for instructing the checkout start was performed. According to the notification, in the transaction processing apparatus 100, the processor 101 determines YES in ACT 217 in FIG. 10 and proceeds to ACT 241 in FIG. 12.

In ACT 241, the processor 101 checks whether a user code was already acquired. For example, if successfully confirming that a user code is set in the field FBC of the transaction data DAA for the transaction, the processor 101 considers that a user code was already acquired, determines YES, and proceeds to ACT 242.

In ACT 242, the processor 101 instructs the user terminal 400 to display a first selection screen. The first selection screen is a screen for causing the user to designate which of smartphone settlement or checkout machine settlement the user wishes to perform. If a notification identifier is included in instruction data for the display instruction for the first selection screen, the notification identifier is assumed to be, for example, notification for requesting notification about which of the smartphone settlement and the checkout machine settlement is performed or notification indicating that a user code was already acquired.

In the user terminal 400, when the instruction data for the display instruction for the first selection screen is received, the processor 401 determines YES in ACT 134 in FIG. 9, proceeds to ACT 136, and updates the display screen of the touch panel 404 to the first selection screen. Since the screen after the update is not the completion screen, the processor 401 determines NO in ACT 137 and returns to the waiting state in ACT 131.

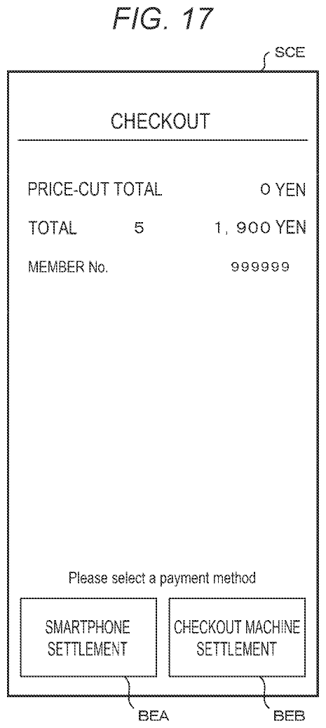

FIG. 17 is a diagram illustrating a first selection screen SCE.

The first selection screen SCE displays a total amount of an applied price-cut, a total number of articles of a transaction commodity, and a settlement amount, displays a user code as a character string, and displays buttons BEA and BEB. The button BEA is a softkey for receiving designation of the smartphone settlement. The button BEB is a softkey for receiving designation of the checkout machine settlement.

On the other hand, for example, if confirming that the field FBC of the transaction data DAA concerning the transaction is the null state, the processor 101 considers that a user code was not acquired, determines NO in ACT 241 in FIG. 12, and proceeds to ACT 243.

In ACT 243, the processor 101 instructs the user terminal 400 to display a second selection screen. The second selection screen is a screen for causing the user to designate the checkout machine settlement. The second selection screen is, for example, a screen obtained by changing the first selection screen SCE to disable the button BEA not to display the button BEA or gray out the button BEA. If a notification identifier is included in instruction data for the display instruction for the second selection screen, the notification identifier is assumed to be, for example, notification for requesting an execution instruction for the checkout machine settlement or notification indicating that a user code was not acquired.

In the user terminal 400, if the instruction data for the display instruction for the second selection screen is received, the processor 401 determines YES in ACT 134 in FIG. 9, proceeds to ACT 136, and updates the display screen of the touch panel 404 to the second selection screen. Since the screen after the update is not the completion screen, the processor 401 determines NO in ACT 137 and returns to the waiting state in ACT 131.

In the user terminal 400, if operation for designating a checkout start is performed, the processor 401 may execute the processing in ACT 241 to ACT 243 in place of the processor 101. In this case, if determining YES in ACT 217 in FIG. 10, the processor 101 proceeds to ACT 244 in FIG. 12.

If operating the user terminal 400 and performing settlement using an online settlement service, the user performs a predetermined operation for designating smartphone settlement, such as tapping the button BEA displayed on the first selection screen SCE. If performing settlement using the checkout machine 200, the user performs a predetermined operation for designating checkout machine settlement, such as tapping the button BEB displayed on the first selection screen SCE or the second selection screen. These operations are notification targets. The processor 401 determines YES in both of ACT 131 and ACT 132 in FIG. 9, proceeds to ACT 133, and notifies the transaction processing apparatus 100 that the operation for designating the smartphone settlement or the checkout machine settlement was performed.

After finishing the display instruction in ACT 242 and ACT 243 in FIG. 12, the processor 101 proceeds to ACT 244 in both the cases.

In ACT 244, the processor 101 waits for an operation to be performed at the user terminal 400. When such an operation occurs, the processor 101 determines YES and proceeds to ACT 245.

In ACT 245, the processor 101 checks whether smartphone settlement was designated. If not, the processor 101 determines NO, checks content of the operation, and proceeds to other processing for performing processing corresponding to the content of the operation. As one kind of the other processing, the processor 101 confirms that the checkout machine settlement was designated and executes processing for causing the checkout machine 200 to perform settlement processing for a price of the transaction being processed. As the other processing, another kind of processing or a plurality of kinds of processing are sometimes selectively performed. However, detailed explanation of the processing is omitted here.

As an example, processing for causing the checkout machine 200 to perform the settlement processing is explained.

The processor 101 instructs the user terminal 400 to display a screen for checkout. The screen for checkout is a screen for handing over checkout processing concerning a transaction to the checkout machine 200. A barcode representing information for the checkout machine 200 to inquire the transaction processing apparatus 100 about the transaction is displayed on the screen for checkout.

In the user terminal 400, if instruction data for the display instruction for the screen for checkout is received, the processor 401 determines YES in ACT 134 in FIG. 9, proceeds to ACT 136, and updates the display screen of the touch panel 404 to the screen for checkout. Since the screen after the update is not the completion screen, the processor 401 determines NO in ACT 137 and returns to the waiting state in ACT 131.

If a plurality of checkout machines 200 are installed in the store, the user optionally selects the checkout machine 200 not in use out of the plurality of checkout machines 200 and causes a barcode scanner included in the checkout machine 200 to read the barcode displayed on the screen for checkout. According to the instruction, the checkout machine 200 requests, based on information represented by the barcode read by the barcode scanner, the transaction processing apparatus 100 to transmit checkout data.

In the transaction processing apparatus 100, if receiving the request for checkout data, the processor 101 transmits, to the checkout machine 200, the requested checkout data for causing the checkout machine 200 to perform settlement of the transaction.

With checkout data transmitted from the transaction processing apparatus 100 in this way, the checkout machine 200 executes, while displaying a screen as appropriate, processing for checking out the transaction based on the checkout data. The processing of the checkout machine 200 may be the same processing as, for example, processing performed in a checkout machine of an existing POS system.

In the transaction processing apparatus 100, upon proceeding from ACT 244 to ACT 245 in FIG. 12 in response to the designating of the smartphone settlement at the user terminal 400 while the first selection screen SCE is displayed, the processor 101 determines YES in ACT 245 and proceeds to ACT 246. If the processor 101 instructs the display of the second selection screen in ACT 243 because a user code was not acquired, the smartphone settlement is not designated and the processor 101 does not proceed to ACT 246.

In ACT 246, the processor 101 instructs the user terminal 400 to display a permission code scan screen. The permission code scan screen is a screen for scanning a barcode representing a permission code. If a notification identifier is included in instruction data for the display instruction for the permission code scan screen, it is assumed that the notification identifier is, for example, a notification identifier for identifying notification for requesting to input the permission code.

In the user terminal 400, if receiving the instruction data for the display instruction for the permission code scan screen, the processor 401 determines YES in ACT 134 in FIG. 9, proceeds to ACT 136, and updates the display screen of the touch panel 404 to the permission code scan screen. Since the screen after the update is not the completion screen, the processor 401 determines NO in ACT 137 and returns to the waiting state in ACT 131.

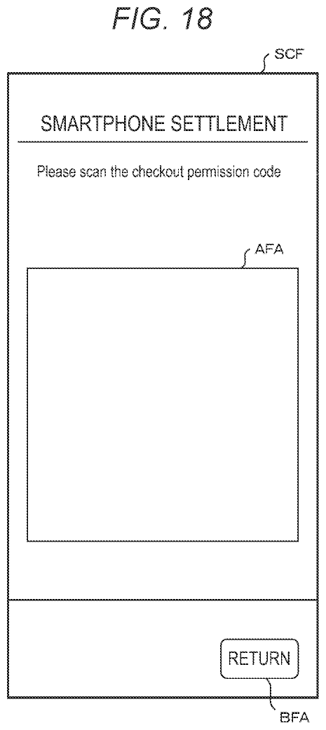

FIG. 18 is a diagram illustrating a permission code scan screen SCF.

The permission code scan screen SCF includes a display area AFA and a button BFA. The display area AFA is an area for displaying an image obtained by the camera 405. The button BFA is a softkey for the user to declare to stop the smartphone settlement.

In the user terminal 400, in displaying the permission code scan screen SCF, the processor 401 starts the camera 405 to thereby superimpose and display an image obtained by the camera 405 in the display area AFA.

At a checkout area (a predetermined region of the store) of the store, a two-dimensional barcode representing a permission code for permitting the smartphone settlement is posted in advance. The posting of the two-dimensional barcode can be performed by, for example, a signboard or posting of a print sheet, poster, or the like. In this context, the checkout area is a specific region of the store in which settlement using the online settlement service is permitted. The checkout area may be determined for each store by an operator or the like of the store as appropriate. The permission code may be different for each store or may be common to a plurality of stores. A one-dimensional barcode representing the permission code may be posted instead of the two-dimensional barcode.

After moving to the checkout area, the user operates the user terminal 400 such that the two-dimensional barcode posted as explained above is reflected in the display area AFA. The processor 401 analyzes an image obtained by the camera 405 and attempts to read the two-dimensional barcode. If the two-dimensional barcode is read, this operation is a notification target. The processor 401 determines YES in both of ACT 131 and ACT 132 in FIG. 9, proceeds to ACT 133, and notifies the transaction processing apparatus 100 that the scan operation was performed and provides the barcode data of the two-dimensional barcode. Consequently, the signboard, the printed sheet, the poster or the like for the posting of the two-dimensional barcode is a medium that is a source for acquisition of the permission code by the user terminal 400.

Upon finishing the display instruction in ACT 246 in FIG. 12, the processor 101 proceeds to ACT 247.

In ACT 247, the processor 101 waits for an operation to be performed at the user terminal 400. When operation content is notified from the user terminal 400, the processor 101 determines YES and proceeds to ACT 248.

In ACT 248, the processor 101 checks whether the permission code is scanned. If not, the processor 101 determines NO, checks content of the operation, and proceeds to other processing for performing processing corresponding to the content of the notified operation. As one kind of the other processing, for example, the processor 101 confirms that operation for designating a smartphone settlement stop, for example, operation of tapping the button BFA was performed, returns to ACT 242, restores the display screen of the touch panel 404 of the user terminal 400 to the first selection screen SCE. As one kind of the other processing, for example, the processor 101 confirms that scan operation of a barcode not representing the permission code was performed, returns to ACT 246 after performing error display, and restores the display screen of the touch panel 404 of the user terminal 400 to the permission code scan screen SCF. The error display is, for example, screen display for notifying the operator that the smartphone settlement cannot be performed unless the permission code is scanned.

If operation notification involving notification of barcode data representing the permission code is performed, the processor 101 considers that the permission coder was scanned, determines YES in ACT 248, and proceeds to ACT 249.

In ACT 249, the processor 101 accesses the online settlement service via the Web and notifies the user terminal 400 of a URL (uniform resource locator) for settlement for causing the user terminal 400 to perform settlement of the transaction. The processor 101 includes, in the URL for settlement, for example, an address for accessing a Web server that provides the online settlement service (hereinafter referred to as settlement server) and settlement data concerning the transaction. For example, the processor 101 makes it possible to determine, from the settlement data, a settlement amount concerning the transaction and a transaction code. For example, the processor 101 makes it possible to determine, from the settlement data, an identifier of a member store of the online settlement service to which the store where the transaction is performed belongs. For example, the processor 101 makes it possible to determine, from the settlement data, an identifier for identifying the transaction processing apparatus 100 in the settlement server. What kind of information the processor 101 makes it possible to determine from the settlement data conforms to the specifications of the online settlement service. A part of information to be included in the settlement data may be transmitted from the user terminal 400 or the transaction processing apparatus 100 to the settlement server by separate communication without being included in the settlement data.

In the user terminal 400, if receiving the notification of the URL for settlement, the processor 401 determines YES in ACT 135 in FIG. 9 and proceeds to ACT 138.

In ACT 138, the processor 401 starts browser processing conforming to the browser program PRE included in the user terminal 400. If the browser processing was already started, the processor 401 skips the processing.

In ACT 139, the processor 401 transfers the URL for settlement notified from the transaction processing apparatus 100 to the browser processing.

In the browser processing, the processor 401 accesses the settlement server based on the URL for settlement transferred from the user terminal processing. Thereafter, in the browser processing, the processor 401 performs settlement using the online settlement service according to an instruction from the settlement server and operations by the user. A procedure of the settlement using the online settlement service may be, for example, a procedure known in an existing online settlement service.

Upon completing the settlement, the settlement server notifies the completion of the settlement to the transaction processing apparatus 100 with the transaction identifier determined from the URL for settlement.

In the transaction processing apparatus 100, after notifying the URL for settlement in ACT 249 in FIG. 12, the processor 101 proceeds to ACT 250.

In ACT 250, the processor 101 waits for completion notification. If the completion of the settlement is notified from the settlement server, the processor 101 determines YES and proceeds to ACT 251.

In ACT 251, the processor 101 instructs the user terminal 400 to display a completion screen. The completion screen is a screen for causing the user to recognize that the transaction was completed. If a notification identifier is included in instruction data for a display instruction for the completion screen, it is assumed that the notification identifier is, for example, a notification identifier for identifying notification that the settlement was completed.

In the user terminal 400, if the instruction data for the display instruction for the completion screen is received, the processor 401 determines YES in ACT 134 in FIG. 9, proceeds to ACT 136, and updates the display screen of the touch panel 404 to the completion screen. Since the screen after the update is the completion screen, the processor 401 determines YES in ACT 137 and proceeds to other processing. As one kind of the other processing, for example, the processor 401 returns to ACT 111 in FIG. 8 in response to operation of, for example, tapping a softkey displayed on the completion screen being performed. As the other processing, another kind of processing or a plurality of kinds of processing are sometimes selectively performed. However, explanation of details of the processing is omitted here.

In ACT 252 in FIG. 12, the processor 101 performs electronic receipt registration processing. That is, in order to make it possible to view content of the transaction of this time in the electronic receipt service, the processor 101 transmits various data such as a list of transaction commodities and a result of the settlement to the electronic receipt server 600. The processor 101 executes the information processing based on the transaction processing program PRA to provide functions of a transmission unit.

Then, the electronic receipt server 600 stores the acquired data in the transaction database and makes it possible to view the content of the transaction with the electronic receipt service. The electronic receipt registration processing may be the same as, for example, processing performed in an existing electronic receipt service. Explanation of details of the electronic receipt registration processing is omitted here. Therefore, the data transmitted to the electronic receipt server 600 by the processor 101 conforms to the specifications of the electronic receipt service.

Thereafter, the processor 101 ends the smartphone POS processing.

If the cart terminal 500 is in a started state, the processor 501 is executing cart terminal processing according to the cart terminal program PRF.

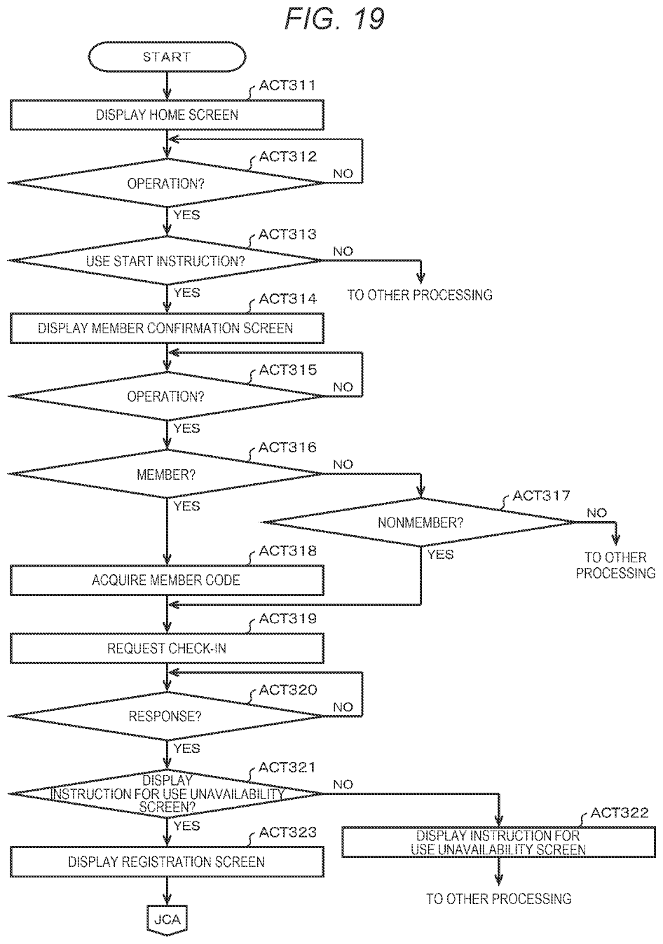

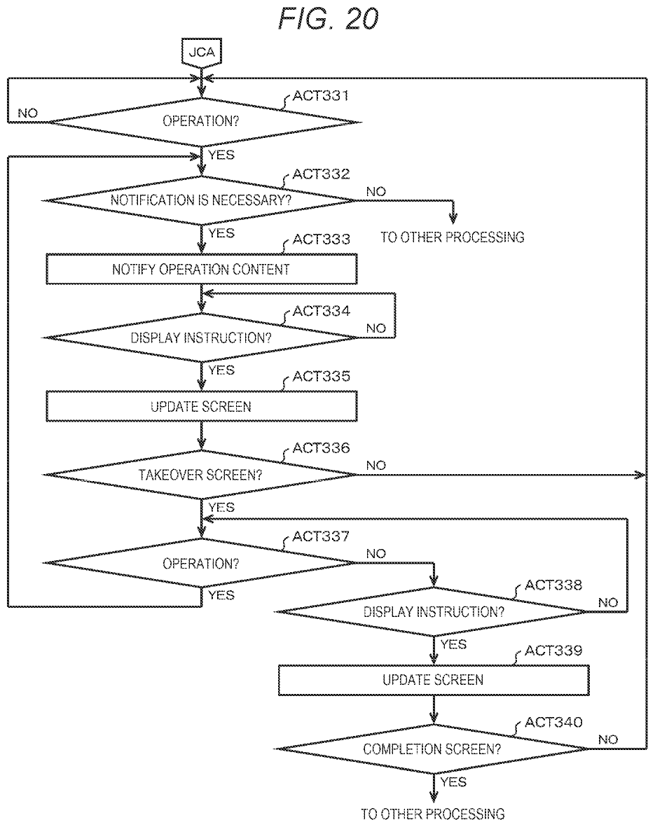

FIGS. 19 and 20 are flowcharts of the cart terminal processing.

In ACT 311, the processor 501 causes the touch panel 504 to display a home screen. The home screen is a screen for causing the operator to designate a function that should be executed out of various functions realized by the cart terminal processing. The home screen displays a softkey for receiving an instruction for a use start by the user.

When the user is about to start use of the cart POS service in the store, the user instructs the use start by, for example, tapping a softkey displayed on the home screen being displayed on the touch panel 504 of a cart terminal 500 that is in an unused state. The operation of the cart terminal 500 by the user at this time is an example of operation for starting registering transaction commodities in a transaction using the cart POS service.

In ACT 312, the processor 501 waits for some operation by the operator to be performed in a state in which the home screen is displayed. If the operation is detected by, the touch panel 504, the processor 501 determines YES and proceeds to ACT 313.

In ACT 313, the processor 501 checks whether the performed operation is for instructing the use start. If not, the processor 101 determines NO, checks content of the operation, and proceeds to other processing for performing processing corresponding to the content of the operation. As one kind of the other processing, for example, the processor 101 performs processing for maintenance according to an operation by an authorized person such as a store clerk.

If the operation for the instruction for the use start is performed, the processor 501 determines YES in ACT 313 and proceeds to ACT 314.

In ACT 314, the processor 501 causes the touch panel 504 to display a member confirmation screen. The member confirmation screen is a screen for inquiring the user whether the user is a member. The member confirmation screen displays a softkey for expressing that the user is a member and a softkey for expressing that the user is a nonmember.

The user expresses that the user is a member with a predetermined operation of, for example, tapping the softkey indicating that the user is a member. Alternatively, the user expresses that the user is a nonmember with a predetermined operation of, for example, tapping the softkey indicating that the user is a nonmember.

In ACT 315, the processor 501 waits for some operation by the user to be performed. If successfully confirming that the operation by the user was performed, the processor 501 determines YES and proceeds to ACT 316.

In ACT 316, the processor 501 checks whether the user expressed that the user is a member. If not, the processor 501 determines NO and proceeds to ACT 317.

In ACT 317, the processor 501 checks whether the user expressed that the user is a nonmember. If not, the processor 501 determines NO, checks content of the operation, and proceeds to other processing for performing processing corresponding to the content of the operation. As one kind of the other processing, for example, the processor 501 confirms that operation for instructing to cancel the use start was performed and returns to ACT 311.

When confirming that the operation for expressing that the user is a member is performed, the processor 501 determines YES in ACT 316 and proceeds to ACT 318.

In ACT 318, the processor 501 acquires a member code. For example, the processor 501 extracts a member code from barcode data represented by a barcode scanned by the scanner 505 from a member card held over the scanner 505 by the user. The processor 501 attempts to acquire a user code concerning the user identified by the member code. The member code and the user code may be the same. In this case, the acquisition of the member code may be regarded as the acquisition of the user code. Alternatively, for example, if a user code is correlated with the acquired member code in a not-illustrated database, the processor 501 acquires the user code.

Thereafter, the processor 501 proceeds to ACT 319. If confirming that the operation for expressing that the user is a nonmember was performed, the processor 501 determines YES in ACT 317, skips ACT 318, and proceeds to ACT 319.

In ACT 319, the processor 501 transmits a check-in request to the transaction processing apparatus 100. For example, the processor 501 delivers request data for the check-in request from the wireless communication unit 506 to the communication network 2 while addressing the request data to the transaction processing apparatus 100. The processor 501 includes, in the request data, check-in data stored in the auxiliary storage unit 503 and a terminal code of the cart terminal 500. The terminal code is stored in, for example, the auxiliary storage unit 503. If successfully acquiring a user code in ACT 318, the processor 501 includes the user code in the request data. As the check-in data, for example, the same check-in data as check-in data represented by a check-in code is written in the auxiliary storage unit 503 in advance. The check-in data written in the auxiliary storage unit 503 may be partially different from the check-in data represented by the check-in code. The terminal code is given to each of a plurality of cart terminals 500 used in the same store and is written in the auxiliary storage unit 503 such that the terminal code can identify each of the cart terminals 500 and does not overlap a terminal code of the user terminal 400. As the terminal code of the cart terminal 500, for example, numerical values “1” to “999” are used.

If the request data is transmitted to the transaction processing apparatus 100 by the communication network 2, in the transaction processing apparatus 100, the communication unit 104 receives the request data and temporarily stores the request data in the main storage unit 102 or the auxiliary storage unit 103.

If the request data delivered from the cart terminal 500 is received by the transaction processing apparatus 100 in this way, the processor 101 starts transaction processing for the cart POS service (hereinafter referred to as cart POS processing) according to the transaction processing program PRA. The smartphone POS processing and the cart POS processing may be respectively described in separate application programs.

If the processor 101 was already executing cart POS processing targeting a transaction concerning a different user, the processor 101 starts new cart POS processing as processing of a thread different from the cart POS processing. If the processor 101 was already executing the smartphone POS processing, the processor 101 starts cart POS processing as processing of a thread different from the smartphone POS processing. That is, the processor 101 may sometimes execute both smartphone POS processing and cart POS processing in parallel. However, the following explanation focuses on only processing of a transaction concerning one user. Therefore, “cart terminal 500” in the following explanation indicates one cart terminal 500 being used by the user for the focused cart POS processing. “Transaction” in the following explanation indicates a transaction set as a target of the focused processing.

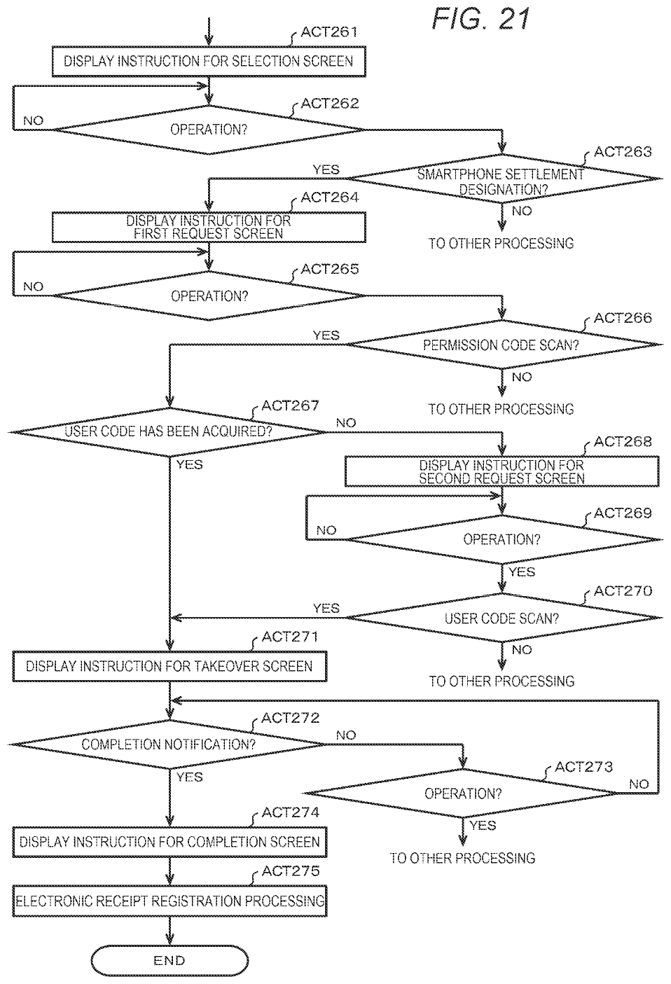

FIG. 21 is a flowchart of the cart POS processing.

In the cart POS processing, the processor 101 performs the kinds of processing illustrated in FIGS. 10 and 11 for the smartphone POS processing in substantially the same manner. However, in the cart POS processing, a terminal used as a user interface is the cart terminal 500. Various screens displayed on the touch panel 504 of the cart terminal 500 may be changed for the cart terminal 500. For example, if the cart terminal 500 is attached to a shopping cart with the touch panel 504 laterally long, the various longitudinally long screens explained above can be changed for the laterally long touch panel 504. For example, if a screen size of the touch panel 504 is larger than a screen size of the touch panel 504, the screen size is changed to display, in one screen, more information than information displayed on the various screens explained above for smartphone POS processing may be adopted. However, the relevant functions and aspects explained above for the various screens are not changed.

Consequently, if the cart terminal 500 is about to be started to be used outside the use available time period, the processor 101 also causes the cart terminal 500 to display a screen having the same function as the use unavailability screen SCA to notify the user that the user cannot start registering transaction commodities using the cart POS service because the present point in time is outside the use available time period. The processor 101 executes the cart POS processing based on the transaction processing program PRA to provide functions of a communication unit.

Therefore, in the cart terminal 500, after requesting the check-in in ACT 319 in FIG. 19, the processor 501 executes ACT 320 to ACT 323 and ACT 331 to ACT 333 in FIG. 20 in the same manner as ACT 118 to ACT 121 in FIG. 8 and ACT 131 to ACT 133 in FIG. 9.

After notifying the operation content in ACT 333, the processor 501 proceeds to ACT 334.

In ACT 334, the processor 501 waits for a display instruction. If instruction data transmitted from the transaction processing apparatus 100 in order to instruct display of some screen is received by the wireless communication unit 506, the processor 501 determines YES and proceeds to ACT 335.

In ACT 335, the processor 501 updates the display screen on the touch panel 504 according to the instruction.

In ACT 336, the processor 501 checks whether the display screen after the update is a takeover screen. If updating the display screen to a screen other than the takeover screen, the processor 501 determines NO and returns to the waiting state in ACT 331. That is, the processor 501 shifts to a state for waiting for operation concerning the screen after the update.

In the transaction processing apparatus 100, the processor 101 proceeds to ACT 261 in FIG. 21 in response to the cart terminal 500 notifying that the operation for instructing the checkout start was performed.

In ACT 261, the processor 101 instructs the cart terminal 500 to display a selection screen. Like the first selection screen, the selection screen is a screen for causing the user to designate which of the smartphone settlement and the checkout machine settlement the user performs.

In the cart terminal 500, if instruction data for a display instruction for the selection screen is received by the wireless communication unit 506, the processor 501 determines YES in ACT 334 in FIG. 20, proceeds to ACT 335, and updates the display screen of the touch panel 504 to the selection screen. Since the screen after the update is not the takeover screen, the processor 501 determines NO in ACT 366 and returns to the waiting state in ACT 331. However, the processor 501 may cause the touch panel 504 to display the selection screen without receiving the display instruction from the processor 101. In this case, for example, the processor 101 skips ACT 261 and proceeds to ACT 262.

If performing the settlement using the online settlement service, the user performs a predetermined operation for designating the smartphone settlement, for example, tapping a button displayed for designating smartphone settlement on the selection screen. If performing the settlement using the checkout machine 200, the user performs a predetermined operation for designating checkout machine settlement, for example, tapping a button displayed for designating the checkout machine settlement on the selection screen. These operations are notification targets. The processor 501 determines YES in both of ACT 331 and ACT 332 in FIG. 20, proceeds to ACT 333, and notifies the transaction processing apparatus 100 that the operation for designating the smartphone settlement or the checkout machine settlement was performed.

In ACT 262 in FIG. 21, the processor 101 waits for operation to be performed at the cart terminal 500. If the operation at the cart terminal 500 is notified to the transaction processing apparatus 100 from the cart terminal 500, the processor 101 determines YES and proceeds to ACT 263.

In ACT 263, the processor 101 checks whether the smartphone settlement was designated. If not, the processor 101 determines NO, checks content of the operation, and proceeds to other processing for performing processing corresponding to the content of the operation. As one kind of the other processing, the processor 101 confirms that the checkout machine settlement was designated and executes processing for causing the checkout machine 200 to perform settlement processing for a price of the transaction being processed. As the other processing, another kind of processing or a plurality of kinds of processing are sometimes selectively performed. However, detailed explanation of the processing is omitted here.

In the transaction processing apparatus 100, upon proceeding from ACT 262 to ACT 263 in response to the operation for designating the smartphone settlement being performed at the cart terminal 500, the processor 101 determines YES in ACT 263 and proceeds to ACT 264.

In ACT 264, the processor 101 instructs the cart terminal 500 to display a first request screen. The first request screen is a screen for requesting the user to cause the cart terminal 500 to scan a permission code. If a notification identifier is included in instruction data for a display instruction for the first request screen, it is assumed that the notification identifier is, for example, a notification identifier for identifying notification for requesting input of the permission code.

At the cart terminal 500, if the operation for designating the smartphone settlement is performed on the selection screen, the processor 501 may cause the touch panel 504 to display the first request screen without receiving the display instruction from the transaction processing apparatus 100. In this case, in the transaction processing apparatus 100, the processor 101 does not execute ACT 264.

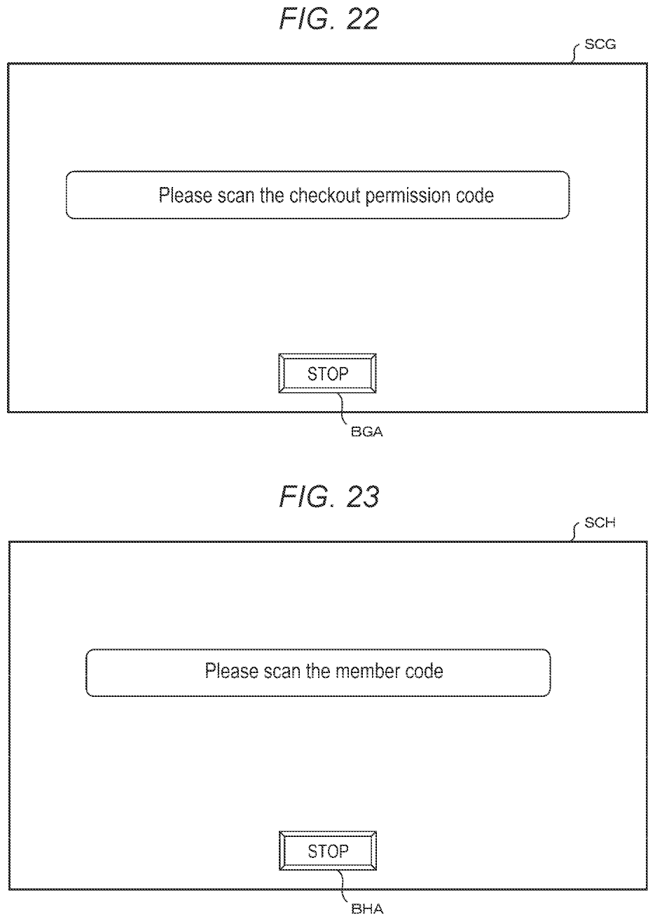

FIG. 22 is a diagram illustrating a first request screen SCG.

The first request screen SCG displays a character message (text) for requesting the user to cause the cart terminal 500 to scan a permission code. The first request screen SCG displays a button BGA. The button BGA is a softkey for receiving an instruction to stop the smartphone settlement.

The user operates the cart terminal 500 to cause the scanner 505 to read a permission code posted in the checkout area. If a two-dimensional barcode is read by the scanner 505, this operation is a notification target. The processor 501 determines YES in both of ACT 331 and ACT 332 in FIG. 20, proceeds to ACT 333, and notifies the transaction processing apparatus 100 that the scan operation was performed. The notification can include the barcode data of the scanned two-dimensional barcode.

Upon finishing the display instruction in ACT 264 in FIG. 21, the processor 101 proceeds to ACT 265.

In ACT 265, the processor 101 waits for operation to be performed in the cart terminal 500. If operation content is notified from the cart terminal 500, the processor 101 determines YES and proceeds to ACT 266.

In ACT 266, the processor 101 checks whether the permission code was scanned. If not, the processor 101 determines NO, checks content of the operation and proceeds to other processing for performing processing corresponding to the content of the operation. As one kind of the other processing, for example, the processor 101 confirms that operation for designating the smartphone settlement stop, for example, operation of tapping the button BGA was performed, returns to ACT 261, and restores the display screen of the touch panel 504 of the cart terminal 500 to the selection screen. As one kind of the other processing, for example, the processor 101 confirms that scan operation for a barcode not representing the permission code was performed, returns to ACT 264 after performing error display, and restores the display screen of the touch panel 504 in the cart terminal 500 to the first request screen SCG. The error display is a screen display for notifying the operator that, for example, the smartphone settlement cannot be performed unless the permission code is scanned. As the other processing, another kind of processing or a plurality of kinds of processing are sometimes selectively performed. However, detailed explanation of the processing is omitted here.

If an operation notification involving notification of barcode data representing the permission code is performed, the processor 101 considers that the permission code was scanned, determines YES in ACT 266, and proceeds to ACT 267. At this time, the processor 101 detects that the cart terminal 500 is an allowed state in which the cart terminal 500 is located in the checkout area set as an allowable range. The processor 101 executes information processing based on the transaction processing program PRA to provide functions of a detection unit.

In ACT 267, the processor 101 checks whether a user code was already acquired. If a user code is not input to the cart terminal 500 as a part of operation for starting use of the cart terminal 500 and check-in data is not successfully acquired because the user code is not delivered together with check-in data from the cart terminal 500, the processor 101 determines NO and proceeds to ACT 268.

In ACT 268, the processor 101 instructs the cart terminal 500 to display a second request screen. The second request screen is a screen for requesting the user to cause the cart terminal 500 to scan a user code. If a notification identifier is included in instruction data for the display instruction for the second request screen, it is assumed that, for example, the notification identifier is a notification identifier for identifying notification for requesting input of a user code.

In the cart terminal 500, if the instruction data for the display instruction for the second request screen is received by the wireless communication unit 506, the processor 501 determines YES in ACT 334 in FIG. 20, proceeds to ACT 335, and updates the display screen of the touch panel 504 to the second request screen. Since the screen after the update is not the takeover screen, the processor 501 determines NO in ACT 366 and returns to the waiting state in ACT 331.

FIG. 23 is a diagram illustrating a second request screen SCH.

The second request screen SCH displays a character message (text) for requesting the user to cause the cart terminal 500 to scan a user code. In the character message, a user code is represented as “member code”. The second request screen SCH displays a button BHA. The button BHA is a softkey for receiving an instruction to stop the smartphone settlement.

The user causes an information communication terminal such as a smartphone owned by the user to display a barcode representing a user code on a screen of the information communication terminal and causes the scanner 505 of the cart terminal 500 to scan the barcode. If the barcode is read by the scanner 505, this operation is a notification target. The processor 501 determines YES in both of ACT 331 and ACT 332 in FIG. 20, proceeds to ACT 333, and notifies the transaction processing apparatus 100 that scan operation was performed.

Upon finishing the display instruction in ACT 268 in FIG. 21, the processor 101 proceeds to ACT 269.

In ACT 269, the processor 101 waits for operation to be performed in the cart terminal 500. If operation content is notified from the cart terminal 500, the processor 101 determines YES and proceeds to ACT 270.

In ACT 270, the processor 101 checks whether the user code is scanned. If not, the processor 101 determines NO, checks content of the operation, and proceeds to other processing for performing processing corresponding to the content of the operation. As one kind of the other processing, for example, the processor 101 confirms that operation for designating the smartphone settlement stop, for example, operation of tapping the button BHA was performed, returns to ACT 261, and restores the display screen of the touch panel 504 of the cart terminal 500 to the selection screen. As one kind of the other processing, for example, the processor 101 confirms that scan operation for a barcode not representing the user code was performed, returns to ACT 268 after performing error display for notifying that the scanned barcode is wrong, and restores the display screen of the touch panel 504 in the cart terminal 500 to the second request screen SCH. As the other processing, another kind of processing or a plurality of kinds of processing are sometimes selectively performed. However, detailed explanation of the processing is omitted here.

If operation notification involving notification of barcode data representing the user code is performed, the processor 101 considers that the user code was scanned, determines YES in ACT 270, and proceeds to ACT 271. If confirming that the user code was already acquired and determining YES in ACT 267, the processor 101 proceeds to ACT 271 without performing ACT 268 to ACT 270.

In ACT 271, the processor 101 instructs the cart terminal 500 to display a takeover screen. The takeover screen is a screen for taking over settlement using the online settlement service to another information communication terminal. As the other information communication terminal, a smartphone is typically used.

In the cart terminal 500, if instruction data for the display instruction for the takeover screen is received by the wireless communication unit 506, the processor 501 determines YES in ACT 334 in FIG. 20, proceeds to ACT 335, and updates the display screen of the touch panel 504 to the takeover screen.

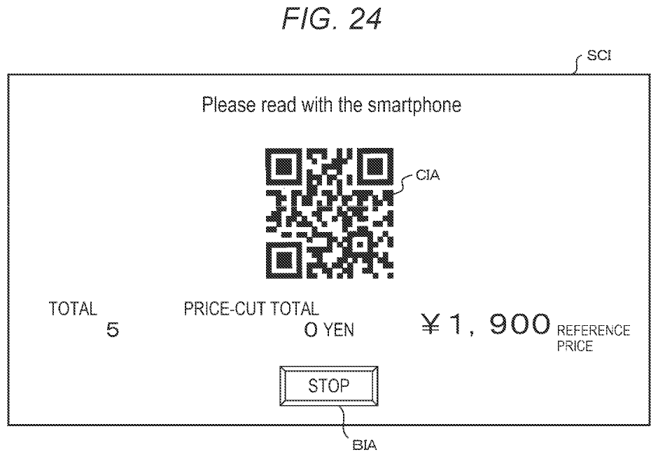

FIG. 24 is a diagram illustrating a takeover screen SCI.

The takeover screen SCI displays a total amount of an applied price-cut, a total number of articles of a transaction commodity, and a settlement amount, displays a user code as a character string, and displays a two-dimensional barcode CIA and a button BIA. The takeover screen SCI displays a character message (text) for requesting the user to cause the information communication terminal used for settlement to read the two-dimensional barcode CIA. The two-dimensional barcode CIA represents takeover data including a URL for settlement and including a command for requesting to execute Web access using the URL for settlement. The button BIA is a softkey for receiving an instruction to stop the smartphone settlement. For example, the processor 101 generates the URL for settlement in the same manner as the URL for settlement notified to the user terminal 400 in ACT 249 in FIG. 12.

The user causes an information communication terminal such as a smartphone owned by the user to read the two-dimensional barcode CIA using a barcode reader function of the information communication terminal. Accordingly, the information communication terminal accesses, with the browser function, the settlement server based on the URL for settlement included in the takeover data represented by the two-dimensional barcode CIA. Thereafter, the information communication terminal performs, with the browser function, according to the instruction from the settlement server and the operation by the user, settlement using the online settlement service. A procedure of the settlement using the online settlement service may be, for example, a procedure known in the existing online settlement service.

The causing the cart terminal 500 to display the takeover screen SCI in this way is equivalent to processing for causing the information communication terminal to perform information processing for the settlement using the online settlement service and transferring a settlement amount to the information processing. The processor 101 starts the processing only if it was detected that the cart terminal 500 is located in the checkout area. The processor 101 executes information processing based on the transaction processing program PRA to provide functions of a processing unit.

In the transaction processing apparatus 100, after performing the display instruction for the takeover screen in ACT 271 in FIG. 21, the processor 101 proceeds to ACT 272.

In ACT 272, the processor 101 checks whether completion notification was performed. If not, the processor 101 determines NO and proceeds to ACT 273.

In ACT 273, the processor 101 checks whether some operation by the user was performed. If not, the processor 101 determines NO and returns to ACT 272.

In this way, in ACT 272 and ACT 273, the processor 101 waits for the completion notification or the operation.

In the cart terminal 500, if proceeding to ACT 366 after causing the touch panel 504 to display the takeover screen in ACT 335 in FIG. 20, the processor 501 determines YES and proceeds to ACT 337.

In ACT 337, the processor 501 checks whether some operation by the user was performed. If not, the processor 501 determines NO and proceeds to ACT 338.

In ACT 338, the processor 501 checks whether a display instruction was performed. If not, the processor 501 determines NO and returns to ACT 337.

In this way, in ACT 337 and ACT 338, the processor 501 waits for the operation or the display instruction.

If an operation of tapping the button BIA displayed on the takeover screen is performed by the user and the operation is detected by the touch panel 504, the processor 501 determines YES in ACT 337, shifts to ACT 332, and repeats processing in ACT 332 and subsequent acts in the same manner as explained above. The operation for instructing to stop the smartphone settlement, such as tapping the button BIA is a notification target. The processor 501 determines YES in both of ACT 331 and ACT 332 in FIG. 20, proceeds to ACT 333, and notifies the operation to the transaction processing apparatus 100.

In the transaction processing apparatus 100, if the operation is notified from the cart terminal 500 in this way, the processor 101 determines YES in ACT 273 in FIG. 21 and proceeds to other processing for performing processing corresponding to content of the notified operation. As one kind of the other processing, for example, the processor 101 confirms that the operation for stopping the smartphone settlement was performed, returns to ACT 261, and restores the display screen of the touch panel 504 of the cart terminal 500 to the selection screen.

Upon completing the settlement processing started in response to the access based on the URL for settlement, the settlement server notifies the completion of the settlement to the transaction processing apparatus 100 along with a transaction code determined from the URL for settlement.

In the transaction processing apparatus 100, if the completion is notified in this way, the processor 101 determines YES in ACT 272 in FIG. 21 in the cart POS processing being executed targeting a transaction identified by the transaction code notified together with the completion and proceeds to ACT 273.

In ACT 273, the processor 101 instructs the cart terminal 500 to display a completion screen. The completion screen is a screen for causing the user to recognize that the transaction was completed. If a notification identifier is included in instruction data for the display instruction for the completion screen, it is assumed that, for example, the notification identifier is a notification identifier for identifying notification to the effect that settlement was completed.

In ACT 274, the processor 101 performs electronic receipt registration processing in the same manner as ACT 252 in FIG. 12.

Thereafter, the processor 101 ends the cart POS processing.

In the cart terminal 500, if the instruction data for the display instruction is received in a state in which the touch panel 504 is displaying the takeover screen, the processor 501 determines YES in ACT 338 in FIG. 20 and proceeds to ACT 339.

In ACT 339, the processor 501 updates the display screen on the touch panel 504 according to the instruction by the instruction data. Once the display of the completion screen is instructed, the processor 501 updates the screen of the touch panel 504 to the completion screen.

In ACT 340, the processor 501 checks whether the display screen after the update is the completion screen. If the screen is updated to the completion screen, the processor 501 determines YES and proceeds to other processing. As one kind of the other processing, for example, the processor 501 returns to ACT 311 in FIG. 19 in response to operation of, for example, tapping a softkey displayed on the completion screen being performed.

Display of a screen other than the completion screen is sometimes instructed in a state in which the touch panel 504 is displaying the takeover screen as in the case in which, for example, the smartphone settlement stop is instructed. In this case, the processor 501 determines NO in ACT 340 and shifts to the waiting state in ACT 331.

According to this embodiment, at the user terminal 400 and the cart terminal 500, a transaction commodity in a transaction can be registered only if a point in time when predetermined operation for a registration start is within the use available time period. Consequently, even if the store is open, it is possible to limit use of the smartphone POS service and/or the cart POS service to certain time periods. Therefore, for example, it is possible perform flexible operation corresponding to convenience on the store side for, for example, limiting the use of the smartphone POS service and the cart POS service to those time periods when a store clerk is not available.

According to this embodiment, if a start of registration of a transaction commodity is suppressed, the user is notified to that effect by the display of the use unavailability screen at the user terminal 400 or the cart terminal 500. Consequently, it is possible to cause the user to recognize that the smartphone POS service and the cart POS service cannot be used at this time.

Various modified implementations of this embodiment are possible.

### (First Modification)

The processor 401 or the processor 501 may determine whether the use unavailability screen SCA is displayed.

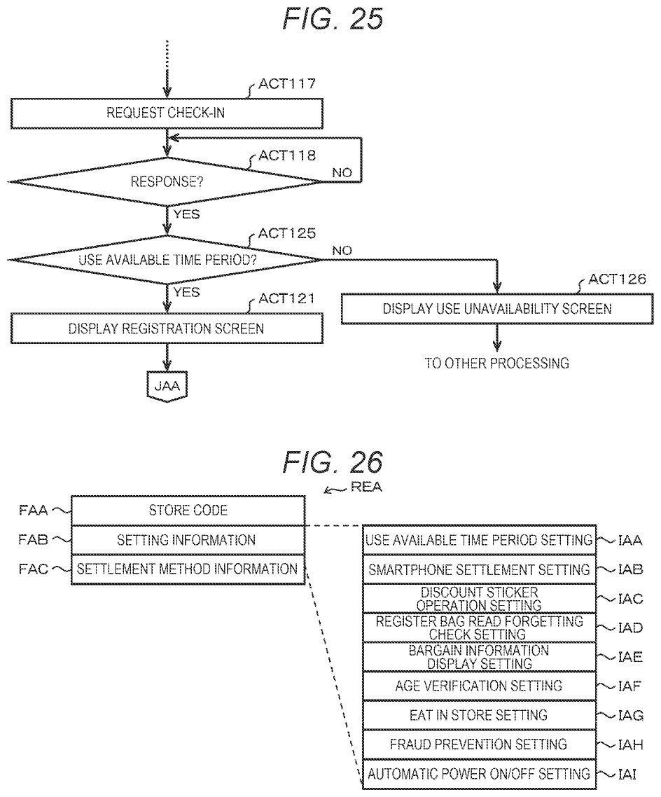

FIG. 25 is a diagram illustrating a modification of the user terminal processing in this case.

The processor 401 executes the user terminal processing in the same manner as in the embodiment up to ACT 118. In this modification, in response to request for check-in, irrespective of whether the present point in time is within the use available time period, the processor 101 transmits, among the setting information correlated with the store codes included in the check-in data in the store database DBA, at least setting information representing the use available time period to the user terminal 400 as a response to the check-in request.

Therefore, if confirming in ACT 118 that the transaction processing apparatus 100 responded, the processor 401 proceeds to ACT 125.

In ACT 125, the processor 401 checks, based on the setting information transmitted from the transaction processing apparatus 100, whether the present point in time is within the use available time period. If the present point in time is not within the use available time period, the processor 401 determines NO and proceeds to ACT 126. In this example, the processor 401 acquires the setting information from the transaction processing apparatus 100. The processor 401 executes the information processing based on the user terminal program PRD to provide functions of an acquisition unit.

In ACT 126, the processor 401 causes the touch panel 404 to display the predetermined use unavailability screen SCA. The processor 401 executes the information processing based on the user terminal program PRD to provide functions of a control unit that notifies, via the touch panel 404 (a display unit), the user that the smartphone POS service is unusable.

If successfully confirming that the present point in time is within the use available time period, the processor 401 determines YES in ACT 125, proceeds to ACT 121, and thereafter advances the processing as in the embodiment explained above.

In the cart terminal 500, the processor 501 also only has to perform the same processing as the processing of the processor 401 explained above.

In the case of the cart terminal 500, information representing the use available time period may be stored in the auxiliary storage unit 503 in advance and the processor 501 may check, based on the information stored in the auxiliary storage unit 503, whether the present point in time is within the use available time period. The information representing the use available time period may be downloaded from the transaction processing apparatus 100, a server provided in the store, or the like and stored in the auxiliary storage unit 503 if the cart terminal 500 is started in in store open preparation or the like or may be written in the auxiliary storage unit 503 in initial setting or the like of the cart terminal 500 as one of operation settings for the cart terminal 500.

It is assumed that the cart terminal 500 performs terminal authentication if the cart terminal 500 is started to be used in a certain store. For example, if a barcode representing a store clerk code (serving as an identifier of a store clerk) is scanned by the scanner 505 while the processor 501 is waiting for a barcode representing a commodity code to be scanned, the processor 501 causes the touch panel 504 to display a terminal authentication screen for inputting a company code serving as an identifier of a company that operates the store, a store code, and a terminal code. If operation for instructing a use start is performed after the company code, the store code, and the terminal code are respectively input, the processor 501 transmits authentication information including the input company code, the input store code, and the input terminal code to the transaction processing apparatus 100. In the transaction processing apparatus 100, the processor 101 authenticates, based on the authentication information transmitted from the cart terminal 500, the cart terminal 500 as the cart terminal 500 identified by the terminal code in a store corresponding to the company code and the store code and transmits an authentication completion response to the cart terminal 500. The cart terminal 500 that receives a response of authentication completion from the transaction processing apparatus 100 shifts to an operation state in which the cart terminal 500 is usable by the user in the store corresponding to the input company code and the input store code. If the processing for the terminal authentication is performed, information representing the use available time period may be acquired by the cart terminal 500 from the transaction processing apparatus 100 together with the response of the authentication completion and written in the auxiliary storage unit 503.

### (Second Modification)

Various kinds of setting information other than the setting information representing the use available time period may be transmitted from the transaction processing apparatus 100 to the user terminal 400 or the cart terminal 500 as a response to a request for check-in in addition to the setting information representing the use available time period or instead of the setting information representing the use available time period.

The processor 101 or the processor 401 controls the various functions of the user terminal 400 based on the setting information and the processor 101 or the processor 501 controls the various functions of the cart terminal 500 based on the setting information. The processor 401 of the user terminal 400 or the processor 501 of the cart terminal 500 may control the various functions based on the setting information after acquiring the setting information from the transaction processing apparatus 100.

Setting information concerning the kind of control can be set in, for example, the field FAB of the data record REA of the store database DBA. Therefore, the kinds of control to be performed or settings for such control can be individually determined for each store.

FIG. 26 is a diagram illustrating a change example of content of the data record REA.

The data record REA illustrated in FIG. 26 includes, as the setting information set in the field FAB, setting information LAB, IAC, IAD, IAE, IAF, LAG, IAH, and LAI in addition to the setting information IAA representing the use available time period.

The setting information IAB represents permission/non-permission of use of the smartphone settlement. For example, the processor 101 or the processor 401 or 501 switches, based on the setting information LAB, whether to execute processing for the smartphone settlement. For example, the processor 101 or the processor 401 does not cause the touch panel 404 to display the first selection screen and does not receive designation of execution of the smartphone settlement based on the setting information IAB for non-permitting use of the smartphone settlement. For example, the processor 101 or the processor 501 does not display a button for designating the smartphone settlement on the selection screen or disables the smartphone settlement and does not receive designation of execution of the smartphone settlement based on the setting information LAB for non-permitting use of the smartphone settlement.

The setting information IAC represents enabling/disabling of operation of a discount sticker. If the operation of the discount sticker is enabled, the setting information IAC also represents a type of the discount sticker to be enabled. For example, the processor 101 or the processor 401 or 501 switches execution/nonexecution of processing for reading the discount sticker.

The setting information LAD represents enabling/disabling of a register bag read forgetting check. For example, the processor 101 or the processor 401 or 501 switches execution/nonexecution of processing for the register bag read forgetting check based on the setting information IAD. If the register bag read forgetting check is enabled, the processor 101 or the processor 401 or 501 causes, in response to operation for instructing a checkout start being performed, the touch panel 404 or 504 to display a screen for inquiring the user about necessity of a register bag. For example, if the register bag is attached with a barcode, the screen is a screen for informing the user to read the barcode. For example, if the register bag is not attached with a barcode, the screen displays a softkey for receiving designation to purchase the register bag.

The setting information LAE represents enabling/disabling of display of bargain information (a campaign, sales promotion of discounted commodities, a coupon, and the like). For example, the processor 101 or the processor 401 or 501 switches, based on the setting information IAE, execution/nonexecution of processing for causing the user terminal 400 or the cart terminal 500 to display the bargain information at appropriate timing.

The setting information IAF represents enabling/disabling of display of an age verification screen at the time when an age limit commodity is registered as a transaction commodity. For example, the processor 101 or the processor 401 or 501 switches, based on the setting information IAF, execution/nonexecution of processing for causing the user terminal 400 or the cart terminal 500 to display the age limit screen.

The setting information IAG represents setting propriety about whether it is possible to eat each commodity in the store. For example, if a candidate commodity is determined anew, the processor 101 or the processor 401 or 501 switches, based on the setting information LAG, execution/nonexecution of processing for determining whether to eat the candidate commodity in the store or take out the candidate commodity.

The setting information IAH represents enabling/disabling of a fraud preventing function. For example, the processor 101 or the processor 401 or 501 switches, based on the setting information IAH, execution/nonexecution of processing for realizing the fraud preventing function. An example of the fraud preventing function is performing, at predetermined timing (for each number of articles or at every change time of registration content), display for automatically imaging the inside of a basket or causing the user to image the inside of the basket and storing a captured image. Another example of the fraud preventing function is imaging or notifying upon detecting that a unregistered commodity has been placed in the basket.

The setting information IAI represents enabling/disabling of an automatic power ON/OFF function. If the automatic power ON/OFF function is enabled, the setting information IAI also represents ON time, OFF time, and a target day of week. For example, the processor 101 or the processor 501 switches, based on the setting information IAI, execution/nonexecution of processing for realizing the automatic power ON/OFF function. The automatic power ON/OFF function is a function of automatically starting the operation of the cart terminal 500 at the ON time of the target day of week and automatically stopping the operation of the cart terminal 500 at the OFF time of the target day of week.

### (Other Modifications)

The processor 401 or 501 may execute a part or all of the processing described as performed by the processor 101 in the transaction processing apparatus 100. For example, the transaction data may be stored in the auxiliary storage unit 403 or 503. The processor 401 or 501 may update the transaction data. In this case, the registration unit is implemented by the information processing by the processor 401 or 501.

A part or all of the functions realized by the processors 101, 301, 401, and 501 with information processing can instead be realized by hardware that executes information processing not based on a program such as a logic circuit. Each of the functions explained above can also be realized by combining software control with the hardware such as a logic circuit.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transaction processing apparatus, comprising:
a communication interface configured to connect to a communication network;
a storage unit for storing a store database with setting information indicating a service available period for a store; and
a processor configured to:
receive a registration start instruction via the communication interface from a terminal apparatus operated by a user in the store;
determine whether the registration start instruction has been received in the service available period for the store by reference to the stored setting information for the store; and
permit the user of the terminal apparatus to register a commodity designated using the terminal apparatus in a sales transaction only if the registration start instruction was received in the service available period for the store.

2. The transaction processing apparatus according to claim 1, wherein the processor is further configured to:
output a notification to the terminal apparatus if the registration start instruction was received outside the service available period.

3. The transaction processing apparatus according to claim 2, wherein the notification causes a display device of the terminal apparatus to display a screen indicating that commodity registration using the terminal apparatus is unavailable.

4. The transaction processing apparatus according to claim 1, wherein the terminal apparatus is a smartphone.

5. The transaction processing apparatus according to claim 1, wherein the terminal apparatus is a cart terminal.

6. An information processing method for a transaction processing server for registering commodities in a sales transaction at a store, the method comprising:
receiving a registration start instruction via a communication interface from a terminal apparatus operated by a user in a store;
determining whether the registration start instruction has been received in a service available period for the store by reference to stored setting information for the store; and
permitting the user of the terminal apparatus to register a commodity designated using the terminal apparatus in a sales transaction only if the registration start instruction was received in the service available period for the store.

7. The information processing method according to claim 6, further comprising:
outputting a notification to the terminal apparatus if the registration start instruction was received outside the service available period.

8. The information processing method according to claim 7, wherein the notification causes a display device of the terminal apparatus to display a screen indicating that commodity registration using the terminal apparatus is unavailable.

9. The information processing method according to claim 6, wherein the terminal apparatus is a smartphone.

10. The information processing method according to claim 6, wherein the terminal apparatus is a cart terminal.

11. A commodity sales system, comprising:
a communication network;
a terminal apparatus communicatively linked to the communication network and configured for receiving an input of a registration start instruction and designations of commodity codes while on a sales floor of a store; and
a transaction processing apparatus including:
a communication interface connected to the communication network;
a storage unit for storing a store database with setting information indicating a service available period for the store; and
a processor configured to:
receive the registration start instruction via the communication interface from the terminal apparatus;
determine whether the registration start instruction has been received in the service available period for the store by reference to the stored setting information for the store; and
permit the user of the terminal apparatus to register a commodity designated by commodity code using the terminal apparatus in a sales transaction only if the registration start instruction was received in the service available period for the store.

12. The commodity sales system according to claim 11, wherein the processor is further configured to:
output a notification to the terminal apparatus if the registration start instruction was received outside the service available period.

13. The commodity sales system according to claim 12, wherein the notification causes a display device of the terminal apparatus to display a screen indicating that commodity registration using the terminal apparatus is unavailable.

14. The commodity sales system according to claim 11, wherein the terminal apparatus is a smartphone.

15. The commodity sales system according to claim 11, wherein the terminal apparatus is a cart terminal.
